(19) United States
(12) Patent Application Publication
(10) Pub. No.: US 2018/0052535 A1
(43) Pub. Date: Feb. 22, 2018

(54) TOUCH PEN, ELECTRONIC DEVICE, AND INPUT METHOD FOR ELECTRONIC DEVICE WITH TOUCH PEN

(71) Applicant: SEMICONDUCTOR ENERGY LABORATORY CO., LTD., Atsugi-shi (JP)

(72) Inventors: Tatsuya SAKUISHI, Atsugi (JP); Kohei YOKOYAMA, Fujisawa (JP); Yasuhiro JINBO, Isehara (JP)

(21) Appl. No.: 15/673,769

(22) Filed: Aug. 10, 2017

(30) Foreign Application Priority Data
Aug. 17, 2016 (JP) 2016-159930

(51) Int. Cl. G06F 3/0354

(52) U.S. Cl. CPC G06F 3/03545; G06F 3/044

(57) ABSTRACT

A highly usable touch pen and a method for providing input to an electronic device using the touch pen are provided. A ball that is formed using a material not slipping on the surface of an input portion of an electronic device and that can rotate in the touch pen is set at the tip of the touch pen. The ball includes an elastic material. Alternatively, the tip of the touch pen is movable. When input is provided to an electronic device by moving the touch pen, the tip of which is provided with the ball formed using a material not slipping on the input portion surface of the electronic device, the ball rolls on the input portion surface while providing input.

### BACKGROUND OF THE INVENTION

### 1. Field of the Invention

One embodiment of the present invention relates to a touch pen, an electronic device, and a method for providing input to an electronic device using a touch pen.

Note that one embodiment of the present invention is not limited to the above technical field. One embodiment of the invention disclosed in this specification and the like relates to an object, a method, or a manufacturing method. One embodiment of the present invention also relates to a process, a machine, manufacture, or a composition of matter. Specifically, examples of the technical field of one embodiment of the present invention disclosed in this specification include a semiconductor device, a display device, a light-emitting device, a power storage device, a memory device, an electronic device, a lighting device, an input device, an input/output device, a sensing device, a driving method thereof, and a manufacturing method thereof.

In this specification and the like, a semiconductor device generally means a device that can function by utilizing semiconductor characteristics. A semiconductor element such as a transistor, a semiconductor circuit, an arithmetic device, and a memory device are each an embodiment of a semiconductor device. An imaging device, a display device, a liquid crystal display device, a light-emitting device, an electro-optical device, a power generation device (including a thin film solar cell, an organic thin film solar cell, and the like), and an electronic device may each include a semiconductor device.

### 2. Description of the Related Art

Touch sensors are widely used as input devices for electronic devices. In particular, touch panels are widely used as input devices for electronic devices with display devices.

For example, input using a pen to a display device including an input portion in a display portion is known (Patent Document 1).

### REFERENCE

### Patent Document

[Patent Document 1] Japanese Published Patent Application No. 2002-287900

### SUMMARY OF THE INVENTION

When input is provided to a touch panel using a pen, if the pen slips on the touch panel (which means that the friction between the touch panel and the pen is small), it is difficult for a user to stably provide character input. In particular, many of the displays that are commercially available use tempered glass for the surface protection. The surface of tempered glass is hard and slippery, which prevents a user from comfortably writing characters or the like with a touch pen.

When a user draws points, lines, figures, and pictures, or writing characters on a piece of paper using a writing instrument such as a pencil, a ballpoint pen, or a fountain pen, for example, appropriate friction is generated between the piece of paper and the writing instrument, so that the user can comfortably draw or write as he/she wants. Since the user is used to that feeling of writing, when he/she writes on a touch panel using a pen, he/she is prone to miswriting because the friction between the touch panel and the pen is so small that the pen slips on the touch panel.

An object of one embodiment of the present invention is to provide a touch pen that can reduce input failures at the time of input to a touch panel. Another object of one embodiment of the present invention is to provide a highly usable touch pen. Another object of one embodiment of the present invention is to provide a method for providing input to a display device including an input portion in a display portion, using the touch pen.

Note that the description of these objects does not preclude the existence of other objects. In one embodiment of the present invention, there is no need to achieve all the objects. Other objects will be apparent from and can be derived from the description of the specification, the drawings, the claims, and the like.

One embodiment of the present invention is a touch pen including a first housing, a second housing provided at an end portion of the first housing, and a first ball. At least a portion of the first ball is provided inside the second housing, and the first ball includes an elastic material.

Another embodiment of the present invention is a touch pen including a first housing, a second housing, a spring provided between the first housing and the second housing, and a first ball. The second housing is movable with respect to the first housing, and at least a portion of the first ball is provided inside the second housing.

In the touch pen, the first ball may include a plurality of protrusions and/or depressions.

In the touch pen, an inner surface of the second housing may include a plurality of protrusions and/or depressions.

In the touch pen, the Young's modulus of the elastic material in the first ball is preferably higher than or equal to 28 MPa and lower than or equal to 107 MPa.

In the touch pen, the first ball preferably includes rubber or plastic.

In the touch pen, the first ball preferably includes a central portion including a first material and a peripheral portion including a second material, and the Young's modulus of the first material is preferably different from the Young's modulus of the second material.

In the touch pen, a second ball may be provided inside the second housing. The second ball may be provided to touch the first ball and the second housing.

Another embodiment of the present invention is a method for providing input to an electronic device including an input portion using a touch pen. The touch pen includes a first housing, a second housing provided at an end portion of the first housing, and a ball. At least a portion of the ball is provided inside the second housing, and the ball includes an elastic material. Input is provided to the electronic device by rotating the ball in the second housing and moving the ball on the input portion.

Another embodiment of the present invention is a method for providing input to an electronic device including an input portion using a touch pen. The touch pen includes a first housing, a second housing, a spring provided between the first housing and the second housing, and a ball. The second housing is movable with respect to the first housing, and at least a portion of the ball is provided inside the second housing. Input is provided to the electronic device by rotating the ball in the second housing and moving the ball on the input portion.

In the above embodiments, the electronic device includes a display portion, and the display portion includes an input portion.

According to one embodiment of the present invention, a touch pen capable of input to a touch panel can be provided, a highly usable touch pen can be provided, or a method for providing input to an electronic device with an input portion using the touch pen can be provided.

Note that the description of these effects does not preclude the existence of other effects. One embodiment of the present invention does not necessarily achieve all the effects listed above. Other effects will be apparent from and can be derived from the description of the specification, the drawings, the claims, and the like.

### BRIEF DESCRIPTION OF THE DRAWINGS

In the accompanying drawings:

FIGS. 1A to 1C illustrate an example of a touch pen;

FIGS. 2A and 2B illustrate a structure of a touch pen;

FIGS. 3A and 3B each illustrate a structure of a touch pen;

FIGS. 4A to 4H each illustrate a structure of a touch pen;

FIGS. 5A and 5B illustrate a structure of a touch pen;

FIG. 6 illustrates a structure of a touch pen;

FIG. 7 illustrates a structure of a touch pen;

FIG. 8 illustrates a structure of a touch pen;

FIGS. 9A to 9D each illustrate a structure of a touch panel;

FIGS. 10A and 10B are a circuit diagram and a timing chart of an example of a touch panel;

FIGS. 11A and 11B illustrate an example of a touch panel;

FIG. 12 illustrates an example of a display device;

FIG. 13 illustrates an example of a display device;

FIG. 14 illustrates an example of a display device;

FIG. 15 illustrates an example of a display device;

FIG. 16 illustrates a structure of a display device;

FIG. 17 illustrates an example of a display device;

FIG. 18 illustrates an example of a display module;

FIGS. 19A to 19G illustrate examples of an electronic device;

FIGS. 20A to 20F illustrate examples of an electronic device; and

FIGS. 21A to 21F illustrate examples of an electronic device.

### DETAILED DESCRIPTION OF THE INVENTION

Embodiments will be described in detail with reference to the drawings. However, the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments.

Note that in structures of the present invention described below, the same portions or portions having similar functions are denoted by the same reference numerals in different drawings, and a description thereof is not repeated. Further, the same hatching pattern is applied to portions having similar functions, and the portions are not especially denoted by reference numerals in some cases.

Note that the position, size, range, or the like of each structure illustrated in drawings and the like is not accurately represented in some cases for easy understanding. Thus, the disclosed invention is not necessarily limited to the position, size, range, or the like as disclosed in the drawings and the like.

Note that in this specification, ordinal numbers such as “first”, “second”, and “third” are used in order to avoid confusion among components, and the terms do not limit the components numerically.

In this specification, terms for describing placement, such as “over”, “above”, “under”, and “below”, are used for convenience in describing a positional relation between components with reference to drawings. Furthermore, a positional relation between components is changed as appropriate in accordance with a direction in which each component is described. Thus, without being limited by the terms used in the specification, the positional relation can be appropriately rephrased in accordance with the situation.

In this specification and the like, a transistor is an element having at least three terminals of a gate, a drain, and a source. The transistor has a channel formation region between the drain (a drain terminal, a drain region, or a drain electrode) and the source (a source terminal, a source region, or a source electrode), and current can flow between the source and the drain through the channel formation region. Note that in this specification and the like, a channel formation region refers to a region through which current mainly flows.

Functions of a source and a drain might be switched when transistors having different polarities are employed or a direction of current flow is changed in circuit operation, for example. Thus, the terms “source” and “drain” can be switched in this specification and the like.

Note that in this specification and the like, the term “electrically connected” includes the case where components are connected through an object having any electric function. There is no particular limitation on the “object having any electric function” as long as electric signals can be transmitted and received between components that are connected through the object. Examples of the “object having any electric function” include a switching element such as a transistor, a resistor, an inductor, a capacitor, and an element with a variety of functions as well as an electrode and a wiring.

For example, any of the following expressions can be used for the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z1 and another part of Z1 is directly connected to X while a drain (or a second terminal or the like) of the transistor is directly connected to one part of Z2 and another part of Z2 is directly connected to Y.

The expressions include, for example, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit configuration is defined by an expression similar to the above examples, a source (or a first terminal or the like) and a drain (or a second terminal or the like) of a transistor can be distinguished from each other to specify the technical scope. Note that these expressions are just examples and the connection relation or order may be expressed in other ways. Here, X, Y, Z1, and Z2 each denote an object (e.g., a device, an element, a circuit, a wiring, an electrode, a terminal, a conductive film, and a layer).

### Embodiment 1

In this embodiment, a touch pen of one embodiment of the present invention will be described.

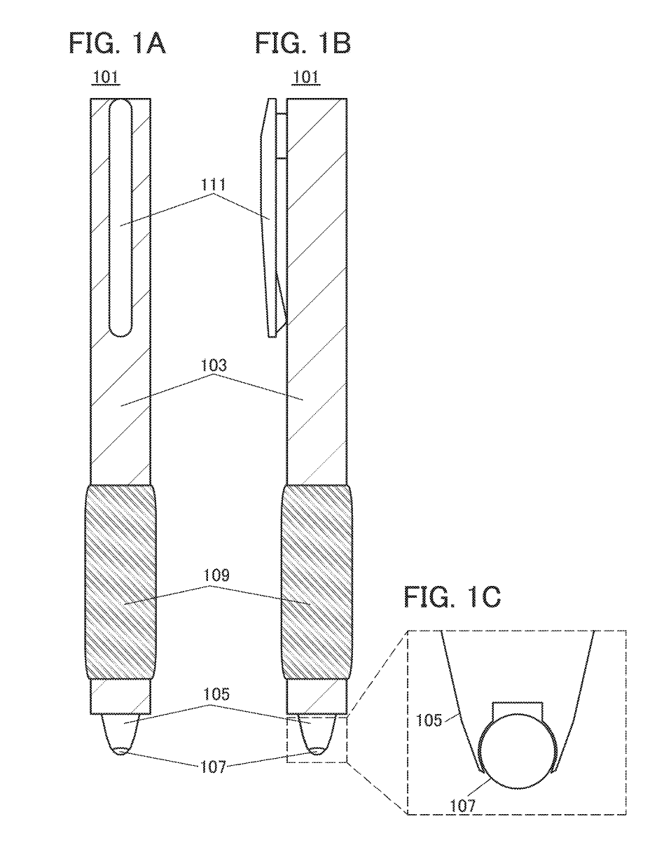

FIG. 1A and FIG. 1B are a front view and a side view of a touch pen 101 of one embodiment of the present invention, respectively. The touch pen 101 includes a housing 103, a housing serving as a ball housing (hereinafter referred to as a ball housing 105) provided at an end portion of the housing 103, and a ball 107 set in the ball housing 105. FIG. 1C is an enlarged cross-sectional view of the ball housing 105 and the ball 107. Part of the ball housing 105 may be inside the housing 103, or part of the ball housing 105 may be fixed to the exterior of the housing 103. The ball 107 is set such that it rotates in the ball housing 105.

Metal or resin such as plastic can be used for the housing 103. The housing 103 may be provided with a grip 109 that prevents the hand or fingers of a user from slipping. The grip 109 may be made of the same material as or a different material from that of the housing 103 and have grooves or protrusions and depressions, or may be made of a material that prevents slip of the hand or fingers of a user, such as rubber. The housing 103 may be provided with a clip 111 that prevents the touch pen from falling from a pocket or a pen case. Metal or resin such as plastic can be used for the ball housing 105.

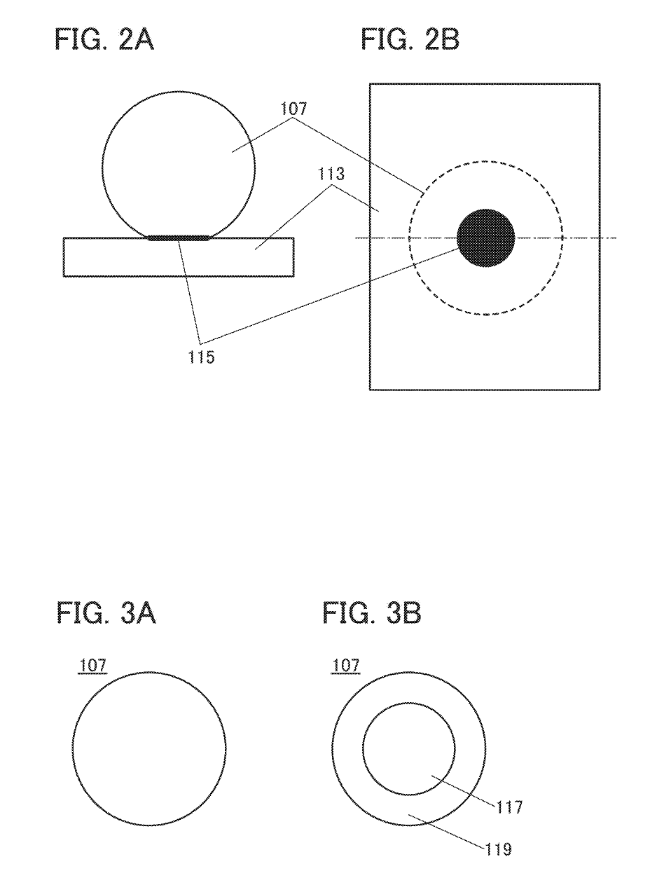

An elastic material is used for at least part of the ball 107, so that the ball 107 changes its shape when touching or pressed to the surface of an electronic device or the surface of a touch panel, which is an input portion of an electronic device. Thus, a user feels like the tip of the touch pen is pressed into the touch panel. Note that, in the following description, the surface of an electronic device and the surface of a touch panel that is an input portion of an electronic device may be collectively referred to as the surface of a touch panel 113 (shown in FIG. 2A) or simply the touch panel 113. Accordingly, the user can have a feeling similar to that of when a writing instrument such as a pencil, a ballpoint pen, or a fountain pen digs into a piece of paper, during input to an electronic device.

FIG. 2A is a cross-sectional view of the ball 107 touching the touch panel 113. FIG. 2B illustrates the contact surface between the ball 107 and the touch panel 113 which is seen from the touch panel 113 side. As shown in FIGS. 2A and 2B, the ball 107 is deformed when the ball 107 touches the touch panel 113, whereby a contact area 115 of the ball 107 and the touch panel 113 increases. As the contact area between the ball 107 and the touch panel 113 increases, friction is generated between the ball 107 and the touch panel 113, thereby preventing the ball 107 from slipping on the touch panel 113. When points, lines, characters, figures, or pictures are input by moving the touch pen 101 on the touch panel 113, the ball 107 does not slip but rotates in the ball housing 105 in accordance with the move of the touch pen 101 so as to provide the input. Thus, a user's input to the electronic device is stable, the user's writing comfort improves, and input failures can be reduced.

The coefficient of static friction between the ball and the touch panel surface is preferably 0.5 or higher, specifically, 0.5 to 0.7 inclusive.

FIGS. 3A and 3B are each a cross-sectional view of the ball 107. The ball 107 as a whole may include the same elastic material, as shown in FIG. 3A. The ball 107 may have a structure that includes a first material 117 which forms the core at the center and a second material 119 around the core, as shown in FIG. 3B. The first material 117 may be an inelastic material and the second material 119 may be an elastic material. The ball 107 may be formed using two or more kinds of elastic materials with different Young's moduli. In that case, an elastic material with a high Young's modulus and an elastic material with a low Young's modulus may be used as the first material 117 and the second material 119, respectively, or an elastic material with a low Young's modulus and an elastic material with a high Young's modulus may be used as the first material 117 and the second material 119, respectively. A material with a different Young's modulus may further be provided between the first material 117 and the second material 119.

A material whose Young's modulus (a modulus of elasticity) is 28 MPa (which corresponds to a hardness of 60 of silicone rubber) to 107 MPa (which corresponds to a hardness of 90 of silicone rubber) inclusive can be used as the elastic material. Typical examples of such a material include rubber and plastic. In the case where the ball includes two or more kinds of materials with different Young's moduli, a material whose Young's modulus is 28 MPa to 40 MPa (which corresponds to a hardness of 70 of silicone rubber) inclusive and a material whose Young's modulus is 66 MPa (which corresponds to a hardness of 80 of silicone rubber) to 107 MPa inclusive may be used in combination. A material whose Young's modulus is 100 MPa to 350 GPa inclusive, preferably 0.5 GPa to 100 GPa inclusive, can be used as the inelastic material. Typical examples of such a material include metal and plastic.

The material of the ball 107 can be selected in accordance with the type of a touch sensor in a touch panel. For a capacitive touch panel, for example, the ball 107 is made conductive. The ball 107 is formed using resin such as rubber or plastic, in which conductive particles or fibers are mixed, for example.

As a conductive material, metal such as copper, nickel, gold, silver, iron, aluminum, titanium, chromium, tantalum, tungsten, or molybdenum; carbon; an organic compound; or the like can be used, for example.

The size of the ball 107 may be appropriately selected in a range of 0.5 mm to 5 mm inclusive in radius, in accordance with the use. In the case where fine points, lines, or characters need to be input, the radius of the ball 107 is preferably 0.5 mm to 2.5 mm inclusive. In contrast, in the case where big points, or bold lines or characters need to be input, the radius of the ball 107 is set to 1 mm to 5 mm inclusive. The electronic device subject to touch input may be controlled so as to recognize a point or line input from a touch panel as having a size larger than the contact area between the touch panel and the ball 107. In that case, the control is exercised by software or an application which is provided in the electronic device.

Thus, making the tip of the touch pen sufficiently thinner than a finger enables fine lines to be drawn, as well as prevents incorrect input made on a small touch panel, a small button or icon displayed on a display portion.

The coefficient of kinetic friction between the touch pen and the touch panel is preferably 0.4 to 0.6 inclusive. With such a coefficient of kinetic friction, a user can provide input to an electronic device, feeling as if he/she is drawing points, lines, symbols, or pictures, or writing characters on a piece of paper with a writing instrument.

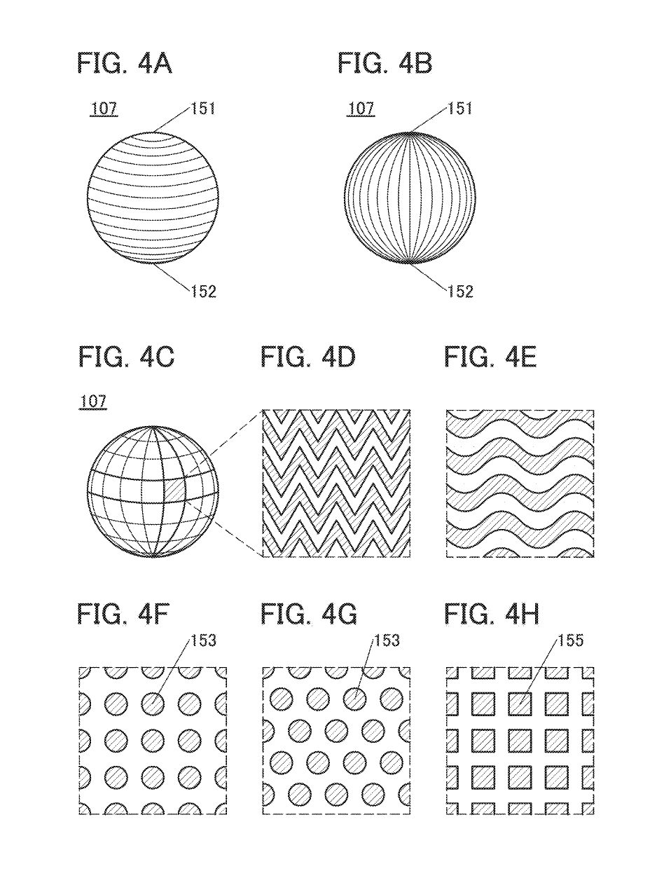

The ball 107 and the ball housing 105 may be designed such that appropriate friction is generated between the ball 107 and the ball housing 105 when the ball 107 rotates in the ball housing 105. FIGS. 4A to 4H are schematic views illustrating modification examples of the ball 107. As shown in FIGS. 4A to 4H, the surface of the ball 107 may have grooves or protrusions and depressions, for example. In FIG. 4A, the ball 107 has circular grooves centered on a pole 151 or a pole 152. In FIG. 4B, the ball 107 has grooves that connect the pole 151 and the pole 152. The grooves on the ball 107 are not limited to straight lines or curved lines. FIGS. 4D and 4E are each an enlarged view of the surface of the ball 107 in FIG. 4C. The grooves may have zigzag shapes as shown in FIG. 4D or wave shapes as shown in FIG. 4E. The shapes of the grooves may be irregular.

FIGS. 4F to 4H are enlarged views of a portion of the surface of the ball 107 in FIG. 4C, each showing an example where the surface of the ball 107 has protrusions and/or depressions. In FIGS. 4F and 4G, the surface of the ball 107 has round protrusions and/or depressions. Round dots 153 are arranged in a grid in FIG. 4F, whereas the round dots 153 are arranged in FIG. 4G such that the space between adjacent ones is uniform. In FIG. 4H, the surface of the ball 107 has square protrusions and/or depressions. In FIG. 4H, squares that are arranged in a grid are shown as an example of polygons 155, but one embodiment of the present invention is not limited thereto. The polygons 155 may be quadrangles such as rectangles, trapezoids, parallelograms, or rhombuses; triangles; pentagons; or polygons with more vertices than pentagons. Furthermore, the arrangement of the polygons 155 is not limited to a grid.

The round dots 153 or polygons 155 may be protrusions on the ball 107, or depressions on the ball 107.

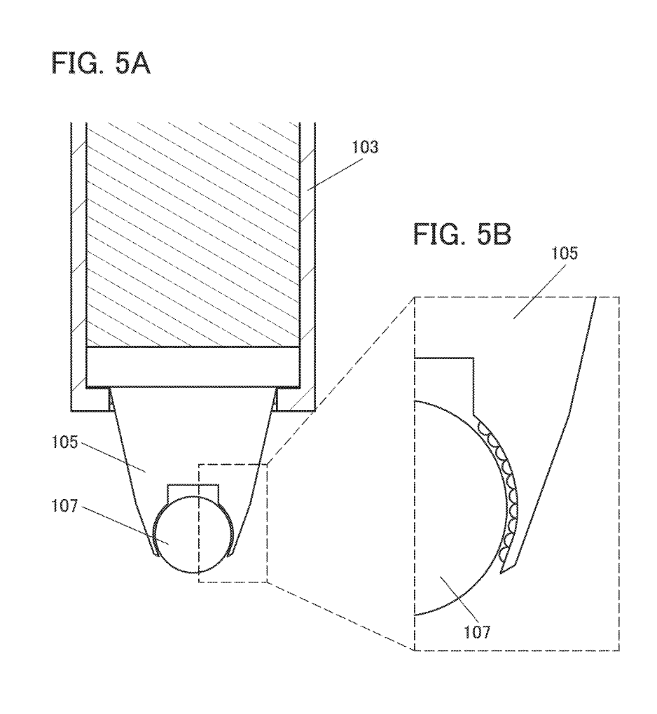

As shown in FIGS. 5A and 5B, the inner surface of the ball housing 105 which is in contact with the ball 107 may have grooves or protrusions and depressions. The surface of the ball 107 and the inner surface of the ball housing 105 may each have grooves or protrusions and depressions. Note that FIG. 5A is an enlarged cross-sectional view of an end portion of the touch pen 101 of this embodiment, and FIG. 5B is a view in which a portion of FIG. 5A is further enlarged.

The depth or height of the grooves or the protrusions and depressions on the surface of the ball 107 or the inner surface of the ball housing 105 can be adjusted as appropriate in accordance with the size of the ball 107. The depth or height of the grooves or the protrusions and depressions is, for example, 1/100 to 1/10 inclusive of the radius of the ball 107. The depth or height of the grooves or the protrusions and depressions on the inner surface of the ball housing 105 may be about the same as that on the surface of the ball 107, but not limited thereto. The depth or height of the grooves or the protrusions and depressions on the inner surface of the ball housing 105 may be greater than that on the surface of the ball 107, or smaller than that on the surface of the ball 107.

FIG. 5B shows an example where protrusions on the inner surface of the ball housing 105 have shapes with curvature, but the shapes are not limited thereto. The shapes of the protrusions on the inner surface of the ball housing 105 may be pointed cones or pyramids, or rectangular.

When the right amount of friction is generated between the ball 107 and the ball housing 105, slips of the touch pen 101 on the touch panel 113 are suppressed and the user's writing comfort improves.

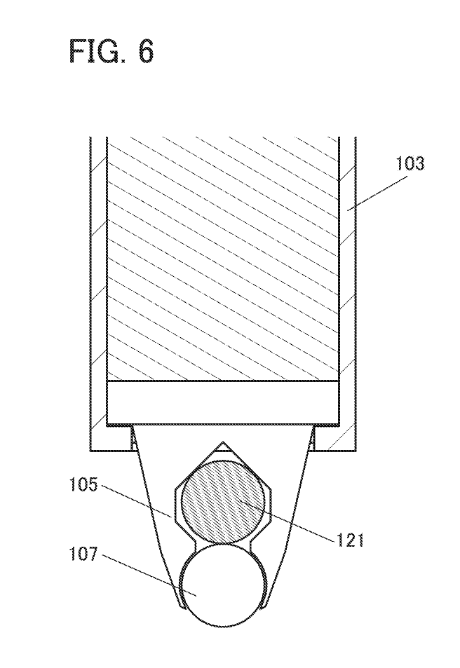

In the case where the friction between the ball 107 and the ball housing 105 is desired to be minimized, another ball 121 may be set in a space in the ball housing 105, as shown in FIG. 6. The ball 121 rotates along with the movement of the ball 107, whereby the rotation of the ball 107 in the ball housing 105 is facilitated. In this manner, the movement of the touch pen 101 on the touch panel becomes smoother, thereby improving the user's writing comfort.

The ball 121 preferably contains metal. The ball housing 105 in contact with the ball 121 also preferably contains metal. Alternatively, a component containing metal may be provided in a portion of the ball housing 105 which is in contact with the ball 121. When the portion in contact with the ball 121 is made of a material containing metal, the ball 121 more easily rotates; as a result, the ball 107 also more easily rotates. However, one embodiment of the present invention is not limited to this. The ball 121 and the ball housing 105 may each contain plastic or glass, other than metal, as long as the ball 121 smoothly rotates in the ball housing 105. The ball 121 is preferably larger than the ball 107 in size, but one embodiment of the present invention is not limited thereto. The ball 121 may be smaller than the ball 107 in size, or the two balls may have the same size.

As described above, with the touch pen of this embodiment, a user can input points, lines, characters, figures, or pictures to an electronic device through a touch panel, feeling as if the writing instrument is digging into a piece of paper. In addition, friction is generated between the ball 107 and the touch panel 113, which prevents the ball 107 from slipping on the touch panel 113. Thus, the user's input to an electronic device is stable. When the touch pen 101 moves on the touch panel 113 to input points, lines, characters, figures, or pictures, the friction between the ball 107 and the ball housing 105 is controlled, and the slip of the touch pen 101 on the touch panel 113 is controlled. Thus, the user's writing comfort improves.

At least part of this embodiment can be implemented in combination with any of the other embodiments described in this specification as appropriate.

### Embodiment 2

In this embodiment, a touch pen of one embodiment of the present invention, which is different from that of Embodiment 1, will be described.

In this embodiment, it is not necessary to use an elastic material for the ball 107, as long as sufficient friction to prevent the ball 107 from slipping is generated without deformation of the ball 107 when the ball 107 in the touch pen touches the touch panel, and as long as a sensor in the touch panel can accurately sense the ball 107. Specifically, it is acceptable if the coefficient of static friction between the ball in the touch pen and the touch panel surface is 0.5 to 0.7 inclusive.

In this embodiment, one mode of a touch pen with which a user can provide input to an electronic device through a touch panel, having a feeling similar to that of when a writing instrument digs into a piece of paper, and which can prevent the surface of the touch panel from being scratched or damaged, will be described.

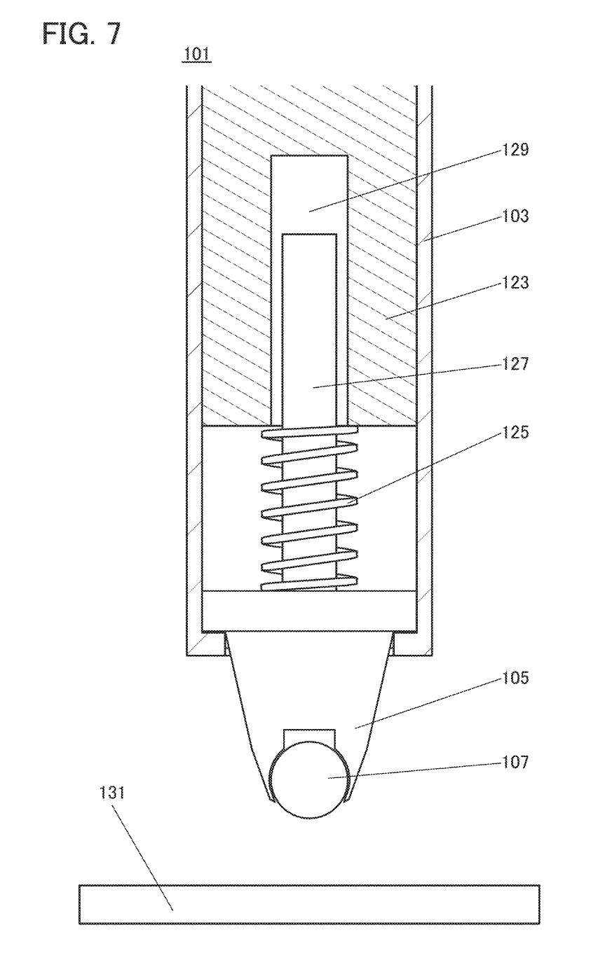

FIG. 7 illustrates the touch pen 101 of this embodiment. Note that the description of portions that are the same as those in Embodiment 1 may be omitted. The touch pen 101 illustrated in FIG. 7 includes the housing 103, a holder 123 in the housing 103, the ball housing 105, a shaft 127 set in the ball housing 105, a spring 125 set between the ball housing 105 and the holder 123, and the ball 107 set in the ball housing 105. For describing the internal structure of the touch pen, cross-sectional views of the housing 103, the holder 123, and the ball housing 105 are included in FIG. 7.

The ball housing 105 is provided with the shaft 127, and the holder 123 is provided with a hole 129 that holds the shaft 127. The holder 123 and the housing 103 may be formed as one component, or the holder 123 may be incorporated in the housing 103 after the holder 123 and the housing 103 are separately formed.

Metal or resin such as plastic can be used for the housing 103. Although not illustrated, similarly to Embodiment 1, the housing 103 may be provided with the grip 109 that prevents the hand or fingers of a user from slipping. The grip 109 may be made of the same material as or a different material from that of the housing 103 and have grooves or protrusions and depressions, or may be made of a material that prevents slip of the hand or fingers of a user, such as rubber. The housing 103 may be provided with the clip 111 that prevents the touch pen from falling from a pocket or a pen case. Metal or resin such as plastic may be used for the ball housing 105.

The ball 107 in the touch pen of this embodiment need not necessarily be formed using an elastic material. Friction is generated between the ball 107 and the touch panel surface, so that a user can stably provide input to a display device. A material having a Young's modulus of 28 MPa to 350 GPa inclusive can be used as the material required for the ball 107. That is to say, the ball 107 may be formed using an elastic material, or the ball 107 formed of an inelastic material that is not deformed during input to a touch panel may be used. Typical examples of the material include rubber, plastic, and metal.

The material of the ball 107 can be selected in accordance with the type of a touch sensor in a touch panel. For a capacitive touch panel, for example, the ball 107 is made conductive. The ball 107 is formed using resin such as rubber or plastic, in which conductive particles or fibers are mixed, for example.

As a conductive material, metal such as copper, nickel, gold, silver, iron, aluminum, titanium, chromium, tantalum, tungsten, or molybdenum; carbon; an organic compound; or the like can be used, for example.

The size of the ball 107 may be appropriately selected in a range of 0.5 mm to 5 mm inclusive in radius, in accordance with the use. In the case where fine points, lines, or characters need to be input, the radius of the ball 107 is preferably 0.5 mm to 2.5 mm inclusive. In contrast, in the case where big points, or bold lines or characters need to be input, the radius of the ball 107 is set to 1 mm to 5 mm inclusive. The electronic device subject to touch input may be controlled so as to recognize a point or line input from a touch panel as having a size larger than the contact area between the touch panel and the ball 107. In that case, the control is exercised by software or an application which is provided in the electronic device.

Thus, making the tip of the touch pen sufficiently thinner than a finger enables fine lines to be drawn, as well as prevents incorrect input made on a small touch panel, a small button or icon displayed on a display portion.

The coefficient of kinetic friction between the touch pen and the touch panel is preferably 0.4 to 0.6 inclusive. With such a coefficient of kinetic friction, a user can provide input to an electronic device, feeling as if he/she is drawing points, lines, symbols, or pictures, or writing characters on a piece of paper with a writing instrument.

The ball 107 and the ball housing 105 may be designed such that appropriate friction is generated between the ball 107 and the ball housing 105 when the ball 107 rotates in the ball housing 105. The structures of the ball 107 and the ball housing 105 may be similar to those in Embodiment 1. For example, the surface of the ball 107 may have grooves or protrusions and depressions, as shown in FIGS. 4A to 4H; the inner surface of the ball housing 105 which is in contact with the ball 107 may have grooves or protrusions and depressions as shown in FIGS. 5A and 5B; or the surface of the ball 107 and the inner surface of the ball housing 105 may each have grooves or protrusions and depressions.

The depth or height of the grooves or the protrusions and depressions on the surface of the ball 107 or the inner surface of the ball housing 105 can be adjusted as appropriate in accordance with the size of the ball 107. The depth or height of the grooves or the protrusions and depressions is, for example, 1/100 to 1/10 inclusive of the radius of the ball 107. The depth or height of the grooves or the protrusions and depressions on the inner surface of the ball housing 105 may be about the same as that on the surface of the ball 107, but not limited thereto. The depth or height of the grooves or the protrusions and depressions on the inner surface of the ball housing 105 may be greater than that on the surface of the ball 107, or smaller than that on the surface of the ball 107.

FIG. 5B shows an example where protrusions on the inner surface of the ball housing 105 have shapes with curvature, but the shapes are not limited thereto. The shapes of the protrusions on the inner surface of the ball housing 105 may be pointed cones or pyramids, or rectangular.

When the right amount of friction is generated between the ball 107 and the ball housing 105, slips of the touch pen 101 on the touch panel 131 are suppressed and the user's writing comfort improves.

In the case where the friction between the ball 107 and the ball housing 105 is desired to be minimized, another ball 121 may be set in a space in the ball housing 105, as shown in FIG. 6, in a similar manner to Embodiment 1. The ball 121 rotates along with the movement of the ball 107, whereby the rotation of the ball 107 in the ball housing 105 is facilitated. In this manner, the movement of the touch pen 101 on the touch panel becomes smoother, thereby improving the user's writing comfort.

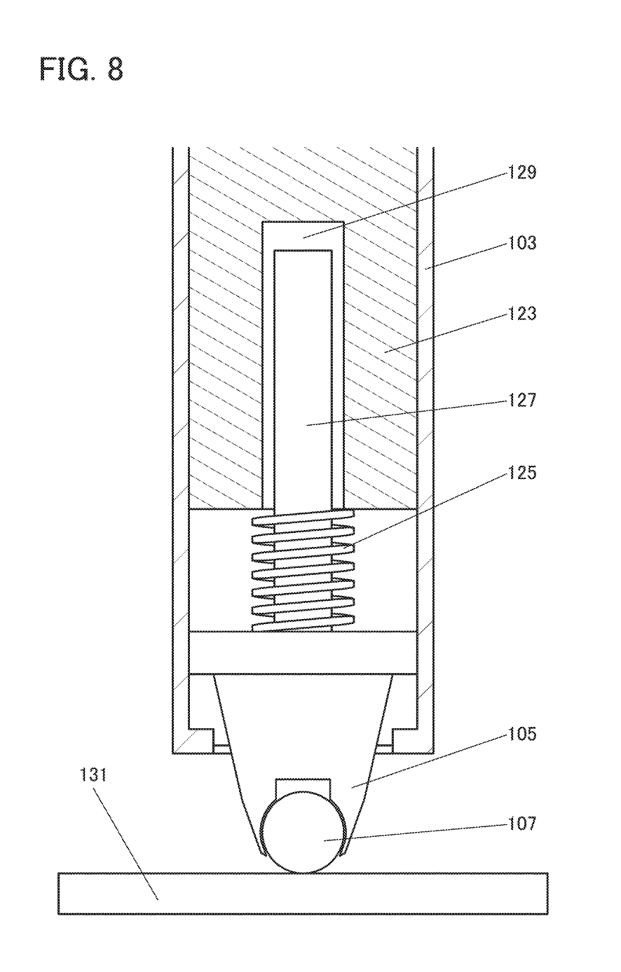

FIG. 8 shows a state in which input is provided to the touch panel 131 using the touch pen of this embodiment. When the touch pen of this embodiment is pressed to the touch panel 131, the spring 125 set between the holder 123 and the ball housing 105 is compressed, whereby the ball 107 and the ball housing 105 are pushed inside the housing 103. Accordingly, a user can have a feeling similar to that of when a writing instrument such as a pencil, a ballpoint pen, or a fountain pen digs into a piece of paper, during input to an electronic device.

In the case where the ball 107 used in the touch pen 101 is made of an inelastic material, the touch panel surface could be scratched or damaged by the ball 107. However, the touch pen 101 of this embodiment has the spring 125 between the holder 123 and the ball housing 105, whereby pressure applied to the touch panel surface by the touch pen 101 is reduced and a scratch or damage to the touch panel surface can be prevented.

As described above, with the touch pen of this embodiment, a user can input points, lines, characters, figures, or pictures to an electronic device through a touch panel, feeling as if the writing instrument is digging into a piece of paper. In addition, friction is generated between the ball 107 and the touch panel 131, which prevents the ball 107 from slipping on the touch panel 131. Thus, the user's input to an electronic device is stable. When the touch pen 101 moves on the touch panel 131 to input points, lines, characters, figures, or pictures, the friction between the ball 107 and the ball housing 105 is controlled, and the slip of the touch pen 101 on the touch panel 131 is controlled. Thus, the user's writing comfort improves.

At least part of this embodiment can be implemented in combination with any of the other embodiments described in this specification as appropriate.

### Embodiment 3

In this embodiment, examples of an electronic device to which input is provided using the touch pen of one embodiment of the present invention and a touch panel used in the electronic device will be described. Although a display device is used as an example of the electronic device with a touch panel in the description of this embodiment, one embodiment of the present invention is not limited thereto. The touch panel of this embodiment can be used in other electronic devices than a display device.

As the touch panel of this embodiment, a capacitive touch panel, a resistive touch panel, an optical touch panel, an infrared touch panel, an electromagnetic touch panel, an ultrasonic touch panel, or the like can be used, for example.

The touch panel of this embodiment may be of an out-cell type, which means a touch sensor is provided over a display screen of a display device. Alternatively, an in-cell touch panel (or a display device with an in-cell touch sensor) or an on-cell touch panel (or a display device with an on-cell touch sensor), in which a touch sensor is incorporated in the display device, may be used.

### <3-1. Examples of Capacitive Touch Panel>

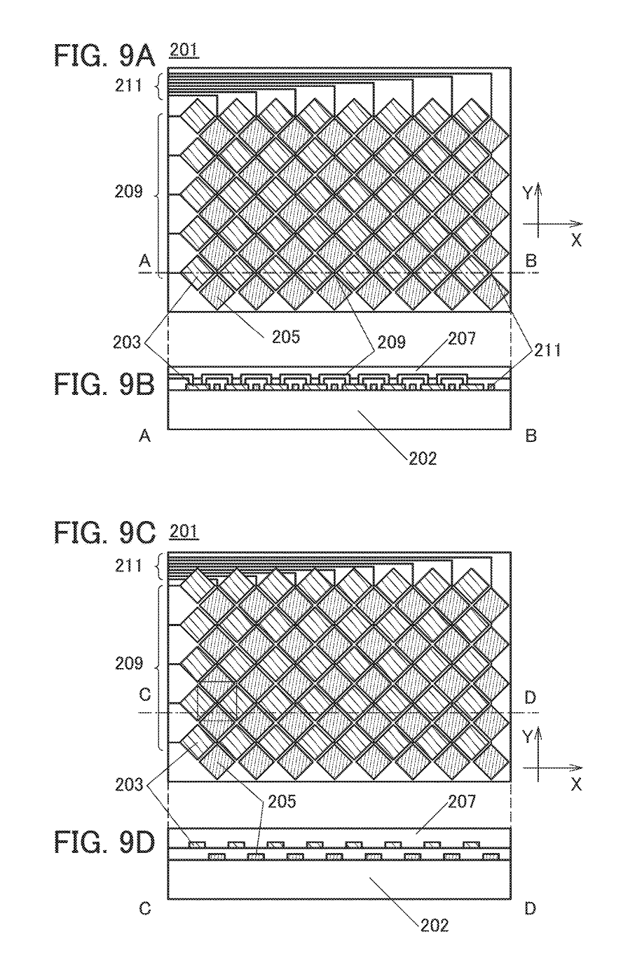

FIGS. 9A to 9D illustrate touch panels of embodiments of the present invention. FIGS. 9A and 9C are top views, FIG. 9B is a cross-sectional view taken along line A-B in FIG. 9A, and FIG. 9D is a cross-sectional view taken along line C-D in FIG. 9C. In a touch panel 201 in which a touch sensor is provided on a display screen, first electrodes 203 each formed of a transparent conductive film and second electrodes 205 each formed of a transparent conductive film are arranged over a substrate 202 so as not to overlap with each other.

As the transparent conductive film, metal oxides such as indium tin oxide (ITO) and zinc oxide (ZnO) can be used, for example.

The first electrodes 203 aligned in X direction in the figure are electrically connected to each other. The second electrodes 205 aligned in Y direction in the figure are electrically connected to each other. The first electrodes 203 and the second electrodes 205 are arranged in a matrix. Such a touch panel is called a capacitive touch panel.

A cover 207 serving as an insulator is provided over the first electrodes 203 and the second electrodes 205. Glass or resin such as plastic may be used for the cover 207, for example.

The first electrodes 203 and the second electrodes 205 may be provided on the same plane (see FIGS. 9A and 9B). In that case, wiring layers 209 each connecting adjacent first electrodes 203 and wiring layers 211 each connecting adjacent second electrodes 205 may additionally be provided.

The first electrodes 203 and the second electrodes 205 may be provided on different planes (see FIGS. 9C and 9D). In that case, parts of the wirings 211 connected to the second electrodes 205 may be provided to overlap with the first electrodes 203, so that the area of the touch panel 201 can be made smaller, which is preferable.

### <3-2. Examples of Sensing Method of Sensor>

For a capacitive touch panel, a self-capacitive method or a mutual capacitive method can be employed as a method for sensing the position of input provided with a finger or a touch pen.

In the self-capacitive method, capacitance is formed between the first electrode 203 or the second electrode 205 at the input position and the finger or touch pen used for the input, and the capacitance is measured to sense the input. To form the capacitance, the tip of the touch pen (i.e., the ball 107 of the touch pen 101 of one embodiment of the present invention) is made conductive. That is, the ball 107 is formed using resin such as rubber or plastic in which conductive particles or fibers are mixed, for example.

As a conductive material, metal such as copper, nickel, gold, silver, iron, aluminum, titanium, chromium, tantalum, tungsten, or molybdenum; carbon; an organic compound; or the like can be used, for example.

The ball 107 formed to contain the above material has conductivity, so that input can be provided by the touch pen of one embodiment of the present invention to an electronic device such as a display device with a self-capacitive touch panel.

In the mutual capacitive method, one of the first electrode and the second electrode is connected to a pulse voltage output circuit 501 while the other is connected to a current detection circuit 502, and change in capacitance formed between the first electrode and the second electrode adjacent to each other is measured to sense the input. For the mutual capacitive method as well, input can be provided to a display device with the touch pen of one embodiment of the present invention including the ball 107, which is formed to contain the above material to have conductivity.

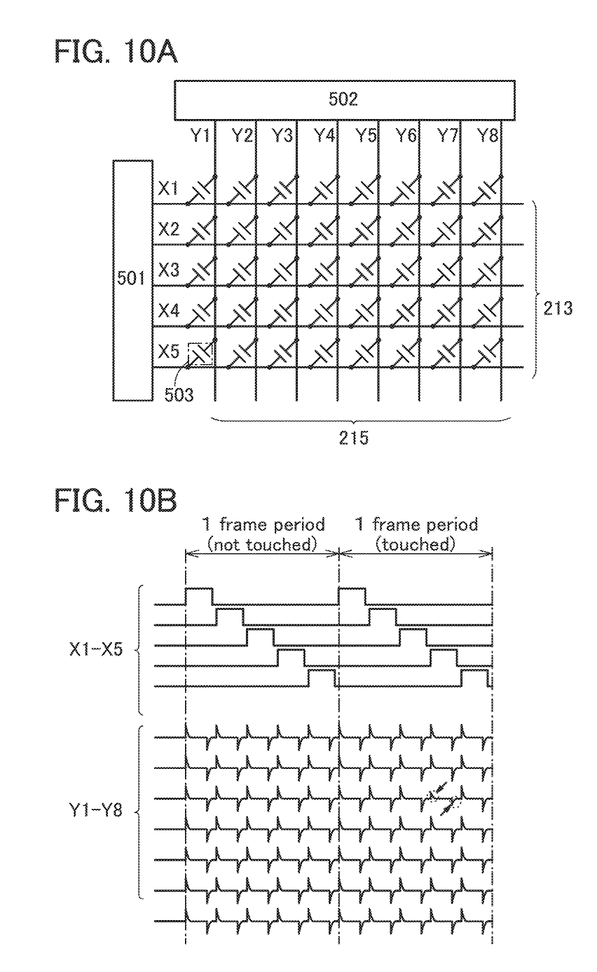

FIG. 10A is a block diagram illustrating the structure of a mutual capacitive touch sensor portion. FIG. 10A illustrates the pulse voltage output circuit 501 and the current detection circuit 502. Note that in FIG. 10A, five wirings X1 to X5 represent electrodes 213 to which pulse voltage is applied, and eight wirings Y1 to Y8 represent electrodes 215 that detect changes in current. FIG. 10A also illustrates a capacitor 503 that is formed near each of intersection points of the electrodes 213 and the electrodes 215.

The pulse voltage output circuit 501 is a circuit for sequentially applying pulse voltage to the wirings X1 to X5. When pulse voltage is applied to the wirings X1 to X5, an electric field is generated between the electrodes 213 and 215 forming the capacitor 503. When the electric field between the electrodes is shielded, for example, a change occurs in mutual capacitance of the capacitor 503. The approach or contact of an object such as a finger or a touch pen can be sensed by utilizing this change.

The current detection circuit 502 is a circuit for detecting changes in current flowing through the wirings Y1 to Y8 that are caused by the change in mutual capacitance in the capacitor 503. No change in current value is detected in the wirings Y1 to Y8 when there is no approach or contact of an object, whereas a current value decreases when mutual capacitance decreases owing to the approach or contact of an object. The current detection circuit 502 detects the change in current value. Note that an integrator circuit or the like is used for detection of current values.

FIG. 10B is a timing chart of input and output waveforms in the mutual capacitive touch sensor portion shown in FIG. 10A. In FIG. 10B, detection of an object is performed in all the rows and columns in one frame period. FIG. 10B separately shows a period in which an object is detected and a period in which no object is detected. For the wirings Y1 to Y8, detected current values are shown as waveforms of voltage values.

Pulse voltages are sequentially applied to the wirings X1 to X5, and waveforms of the wirings Y1 to Y8 change in accordance with the pulse voltages. When there is no approach or contact of an object, the waveforms of the wirings Y1 to Y8 change in accordance with changes in the voltages of the wirings X1 to X5. When there is approach or contact of an object, the current value decreases at the point of approach or contact of the object and accordingly the waveform of the voltage value changes.

By detecting a change in mutual capacitance in this manner, the approach or contact of an object can be sensed.

A user can input points, lines, characters, figures, or pictures to a display device using his/her finger or the touch pen over the cover 207. Using the touch pen of one embodiment of the present invention, the user can provide input to the display device, feeling as if he/she is drawing with a writing instrument on a piece of paper.

Although capacitance is formed between the first electrodes 203 and the second electrodes 205, each formed of a transparent conductive film, that are provided not to overlap with each other in the touch panel 201 of this embodiment, one embodiment of the present invention is not limited thereto. The first electrodes 203 and the second electrodes 205 may be formed by processing a conductive film or conductive films over the substrate 202 into wiring-like or net-like shapes. It is also possible to form electrodes in wiring-like or net-like shapes over the substrate 202 using nanowires, which are fine wirings with a diameter of 1 nm to 100 nm inclusive.

### <3-3. Example of Resistive Touch Panel>

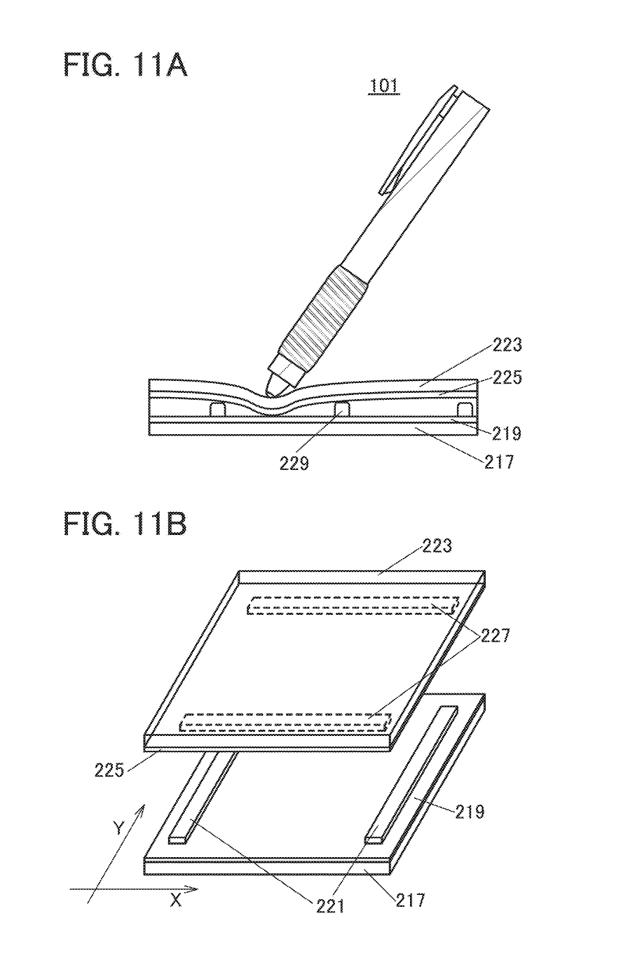

FIGS. 11A and 11B illustrate a touch panel in another mode of this embodiment. FIG. 11A is a cross-sectional view and FIG. 11B is a perspective view of the touch panel. Note that the positions of some components are shifted in FIG. 11B for easier description of the touch panel of this embodiment.

A conductive film 219 formed using a metal oxide such as indium tin oxide (ITO) or zinc oxide (ZnO), for example, is provided over a base 217 which is glass, resin such as plastic, a film, or the like. A pair of electrodes 221 is provided along two opposite sides over the base 217. Here, the pair of electrodes 221 is provided parallel to Y direction in the figure. A film 223 is provided to face the base 217. A conductive film 225 formed using a metal oxide such as indium tin oxide (ITO) or zinc oxide (ZnO), for example, and a pair of electrodes 227 along two opposite sides are provided on the base 217 side of the film 223. Here, the pair of electrodes 227 is provided parallel to X direction in the figure. That is, the pair of electrodes 227 is formed over the film 223 so as to be perpendicular to the pair of electrodes 221 formed over the base 217. A spacer 229 is provided between the base 217 and the film 223 to keep the space between the base 217 and the film 223. A touch panel having such a structure is called a resistive touch panel.

When a finger or a touch pen pushes the touch panel from the film side, the conductive film 225 on the film 223 touches the conductive film 219 on the base 217, whereby the touch input position is detected.

When voltage is applied to one of the pair of electrodes 227 on the film 223 side, a potential gradient in Y direction is generated owing to resistance of the conductive film 225. The potential at the touch input position is detected through the conductive film 219 and the electrode 221 on the base 217 side, and the coordinate of the touch input position in Y direction can be detected by means of voltage division. Furthermore, when voltage is applied to one of the pair of electrodes 221 on the base 217 side, a potential gradient in X direction is generated owing to resistance of the conductive film 219 on the base 217. The potential at the touch input position is detected through the conductive film 225 and the electrode 227 on the film 223 side, and the coordinate of the touch input position in X direction can be detected.

A user can input points, lines, characters, figures, or pictures to a display device using his/her finger or the touch pen over the film 223. Using the touch pen of one embodiment of the present invention, the user can provide input to the display device, feeling as if he/she is drawing with a writing instrument on a piece of paper.

<3-4. Examples of Display Device with Out-Cell Touch Panel>

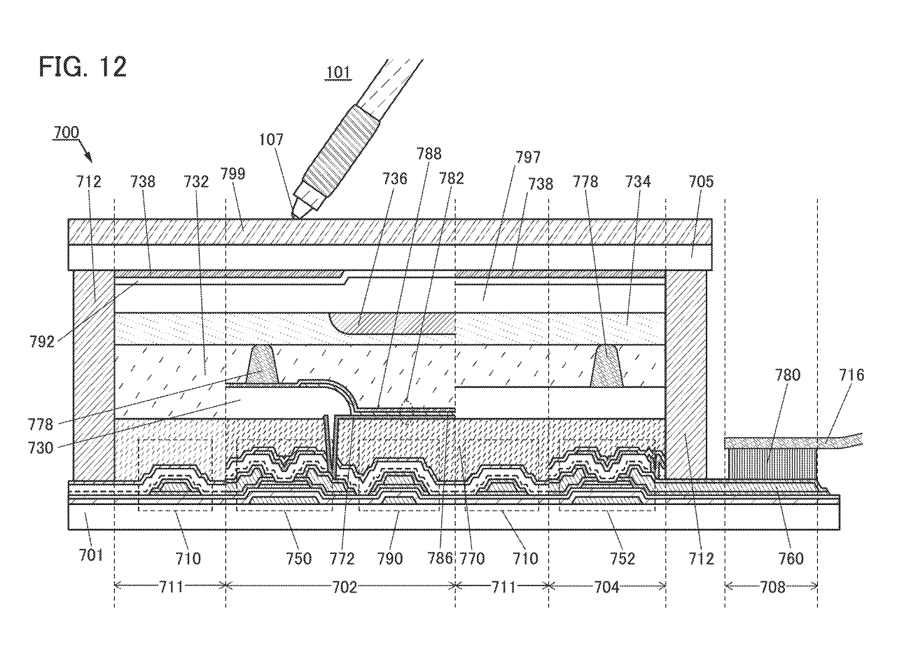

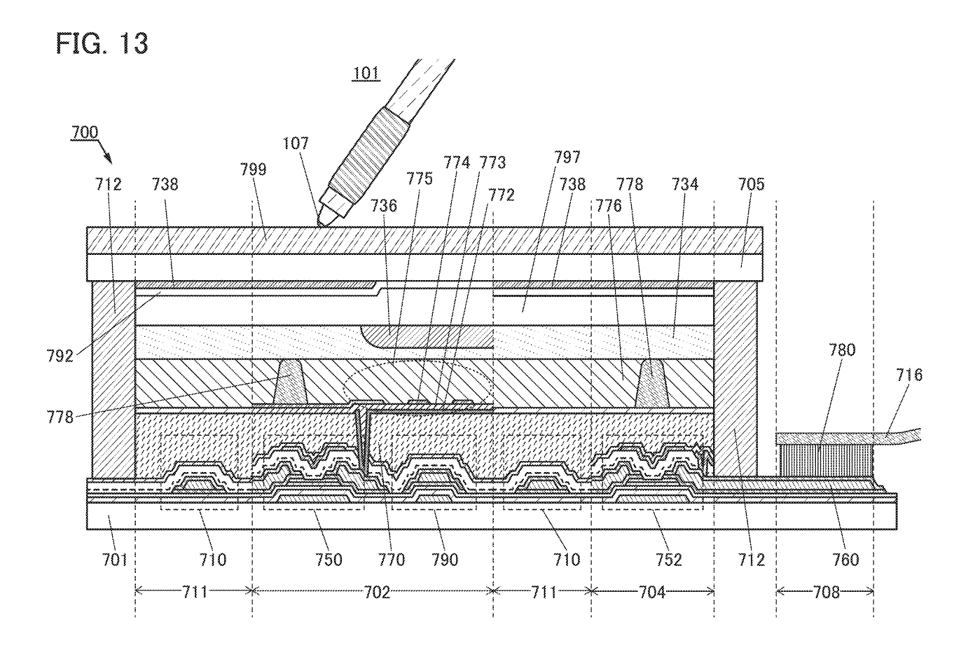

FIG. 12 and FIG. 13 are each a schematic cross-sectional view of a display device with a so-called out-cell touch panel, in which the touch panel of this embodiment is provided over a display panel. FIG. 12 and FIG. 13 show an example in which an EL display device is used and an example in which a liquid crystal display device is used, respectively; however, the display device to be used is not limited thereto. For example, display devices that perform display by an electrophoretic method, an Electronic Liquid Powder (registered trademark) method, an electrowetting method, or the like (such a display device is also referred to as electronic paper); MEMS shutter display devices; and optical interference type MEMS display devices may also be used.

In addition, a transmissive liquid crystal display device, a transflective liquid crystal display device, a reflective liquid crystal display device, a direct-view liquid crystal display device, or the like can be used as the liquid crystal display device.

For the EL display device, organic electroluminescence elements emitting light of different colors may be provided in different subpixels, or an organic electroluminescence element emitting white light may be used. In the case where an organic electroluminescence element emitting white light is used, a color filter may be provided on the side to which light is emitted, so as to enable color display.

The touch panel of this embodiment may be provided in other electronic devices than a display device. The touch panel of this embodiment may be provided in an electronic device having no display device, or the touch panel of this embodiment may be provided in any other portion of a display device than a display portion.

Hereinafter, portions that are common to the EL display device in FIG. 12 and the liquid crystal display device in FIG. 13 will be described first, and different portions will be described next.

### <3-5. Portions Common to Display Devices>

A display device 700 illustrated in FIG. 12 and FIG. 13 includes a lead wiring portion 711, a pixel portion 702, a source driver circuit portion 704, and an FPC terminal portion 708. The lead wiring portion 711 includes a signal line 710. The pixel portion 702 includes a transistor 750 and a capacitor 790. The source driver circuit portion 704 includes a transistor 752.

The capacitor 790 includes a lower electrode that is formed through a step of processing the same conductive film as a conductive film functioning as a first gate electrode of the transistor 750 and an upper electrode that is formed through a step of processing the same conductive film as a conductive film functioning as a source electrode or a drain electrode of the transistor 750. Between the lower electrode and the upper electrode, an insulating film that is formed through a step of forming the same insulating film as an insulating film functioning as a first gate insulating film of the transistor 750 is provided. That is, the capacitor 790 has a stacked-layer structure in which an insulating film functioning as a dielectric film is positioned between a pair of electrodes.

In FIG. 12 and FIG. 13, a planarization insulating film 770 is provided over the transistor 750, the transistor 752, and the capacitor 790.

The planarization insulating film 770 can be formed using a heat-resistant organic material, such as a polyimide resin, an acrylic resin, a polyimide amide resin, a benzocyclobutene resin, a polyamide resin, or an epoxy resin. Note that the planarization insulating film 770 may be formed by stacking a plurality of insulating films formed from these materials. The planarization insulating film 770 need not necessarily be provided.

Although FIG. 12 and FIG. 13 each illustrate an example in which the transistor 750 included in the pixel portion 702 and the transistor 752 included in the source driver circuit portion 704 have the same structure, one embodiment of the present invention is not limited thereto. For example, the pixel portion 702 and the source driver circuit portion 704 may include different transistors. Specifically, a structure in which a staggered transistor is used in the pixel portion 702 and an inverted staggered transistor is used in the source driver circuit portion 704, or a structure in which an inverted staggered transistor is used in the pixel portion 702 and a staggered transistor is used in the source driver circuit portion 704 may be employed. Note that the term “source driver circuit portion 704” may be replaced by the term “gate driver circuit portion”.

A signal line 710 is formed through the same process as the conductive films functioning as source electrodes and drain electrodes of the transistors 750 and 752. In the case where the signal line 710 is formed using a material including a copper element, signal delay or the like due to wiring resistance is reduced, which enables display on a large screen.

The FPC terminal portion 708 includes a connection electrode 760, an anisotropic conductive film 780, and an FPC 716. Note that the connection electrode 760 is formed through the same process as the conductive films functioning as source electrodes and drain electrodes of the transistors 750 and 752. The connection electrode 760 is electrically connected to a terminal included in the FPC 716 through the anisotropic conductive film 780.

A glass substrate can be used, for example, as each of a first substrate 701 and a second substrate 705. A flexible substrate may be used as each of the first substrate 701 and the second substrate 705. Examples of the flexible substrate include a plastic substrate.

The first substrate 701 and the second substrate 705 are attached to each other with a sealant 712. A structure body 778 is provided between the first substrate 701 and the second substrate 705. The structure body 778 is a columnar spacer obtained by selectively etching an insulating film, and provided to control the distance (cell gap) between the first substrate 701 and the second substrate 705. Note that a spherical spacer may also be used as the structure body 778.

Furthermore, a light-blocking layer 738 functioning as a black matrix and a coloring layer 736 functioning as a color filter are provided on the second substrate 705 side. An insulating film 792 may be provided to cover the light-blocking layer 738. An insulating film 797 may also be provided as a planarization film between the light-blocking layer 738 and the coloring layer 736. In addition, an insulating film 734 is provided to cover the light-blocking layer 738 and the coloring layer 736.

A touch panel 799 described in this embodiment is provided over the second substrate 705. A touch panel that can be used for the display device described in this embodiment is not limited to a capacitive touch panel and a resistive touch panel. As mentioned above, the touch panel 799 that can be used for the display device described in this embodiment can be an optical touch panel, an infrared touch panel, an electromagnetic touch panel, an ultrasonic touch panel, or the like.

### <3-6. Display Device Including Light-Emitting Element>

The display device 700 illustrated in FIG. 12, which includes a light-emitting element 782, is what we call an EL display device. The light-emitting element 782 includes a conductive film 772, an EL layer 786, and a conductive film 788. The display device 700 illustrated in FIG. 12 can display an image by utilizing light emission from the EL layer 786 of the light-emitting element 782. Note that the EL layer 786 contains an organic compound or an inorganic compound such as a quantum dot.

Examples of materials that can be used for an organic compound include a fluorescent material and a phosphorescent material. Examples of materials that can be used for a quantum dot include a colloidal quantum dot material, an alloyed quantum dot material, a core-shell quantum dot material, and a core quantum dot material. A material containing elements belonging to Groups 12 and 16, elements belonging to Groups 13 and 15, or elements belonging to Groups 14 and 16, may be used. Alternatively, a quantum dot material containing an element such as cadmium (Cd), selenium (Se), zinc (Zn), sulfur (S), phosphorus (P), indium (In), tellurium (Te), lead (Pb), gallium (Ga), arsenic (As), or aluminum (Al) may be used.

In the display device 700 in FIG. 12, an insulating film 730 is provided over the planarization insulating film 770 and the conductive film 772. The insulating film 730 covers part of the conductive film 772. Note that the light-emitting element 782 has a top-emission structure. Thus, the conductive film 788 has a light-transmitting property and transmits light emitted from the EL layer 786. Although the top-emission structure is described as an example in this embodiment, the structure is not limited thereto. For example, a bottom-emission structure in which light is emitted to the conductive film 772 side or a dual-emission structure in which light is emitted to both the conductive film 772 side and the conductive film 788 side may also be employed. In that case, the touch panel 799 is provided under the first substrate 701.

The coloring layer 736 is provided to overlap with the light-emitting element 782, and the light-blocking layer 738 is provided in the lead wiring portion 711 and the source driver circuit portion 704 to overlap with the insulating film 730. The coloring layer 736 and the light-blocking layer 738 are covered with the insulating film 734. A space between the light-emitting element 782 and the insulating film 734 is filled with a sealing film 732. The structure of the display device 700 is not limited to the example in FIG. 12, in which the coloring layer 736 is provided. For example, a structure without the coloring layer 736 may also be employed in the case where the EL layer 786 is formed by separate coloring.

### <3-7. Structure Example of Display Device Including Liquid Crystal Element>

The display device 700 illustrated in FIG. 13 includes a liquid crystal element 775. The liquid crystal element 775 includes a conductive film 772, an insulating film 773, a conductive film 774, and a liquid crystal layer 776. In such a structure, the conductive film 774 functions as a common electrode, and an electric field generated between the conductive film 772 and the conductive film 774 through the insulating film 773 can control the alignment state of the liquid crystal layer 776. The display device 700 in FIG. 13 is capable of displaying an image in such a manner that transmission or non-transmission is controlled by change in the alignment state of the liquid crystal layer 776 depending on a voltage applied to the conductive film 772 and the conductive film 774.

The conductive film 772 is electrically connected to the conductive film functioning as the source electrode or the drain electrode of the transistor 750. The conductive film 772 is formed over the planarization insulating film 770 and functions as a pixel electrode, that is, one electrode of the display element.

A conductive film that transmits visible light or a conductive film that reflects visible light can be used as the conductive film 772. A material containing an element selected from indium (In), zinc (Zn), and tin (Sn) may be used for the conductive film that transmits visible light, for example. A material containing aluminum or silver may be used for the conductive film that reflects visible light, for example. In this embodiment, the conductive film that reflects visible light is used as the conductive film 772.

Although FIG. 13 illustrates an example in which the conductive film 772 is connected to the conductive film functioning as the drain electrode of the transistor 750, one embodiment of the present invention is not limited to this example. For example, the conductive film 772 may be electrically connected to the conductive film functioning as the drain electrode of the transistor 750 through a conductive film functioning as a connection electrode.

Although not shown in FIG. 13, an alignment film may be provided in contact with the liquid crystal layer 776. Although not illustrated in FIG. 13, an optical member (optical substrate) and the like such as a polarizing member, a retardation member, or an anti-reflection member may be provided as appropriate. For example, circular polarization may be employed by using a polarizing substrate and a retardation substrate. In addition, a backlight, a side light, or the like may be used as a light source.

In the case where a liquid crystal element is used as the display element, a thermotropic liquid crystal, a low-molecular liquid crystal, a high-molecular liquid crystal, a polymer dispersed liquid crystal, a ferroelectric liquid crystal, an anti-ferroelectric liquid crystal, or the like can be used. These liquid crystal materials exhibit a cholesteric phase, a smectic phase, a cubic phase, a chiral nematic phase, an isotropic phase, or the like depending on conditions.

In the case where a horizontal electric field mode is employed, a liquid crystal exhibiting a blue phase for which an alignment film is unnecessary may be used. The blue phase is one of liquid crystal phases, which is generated just before a cholesteric phase changes into an isotropic phase when the temperature of a cholesteric liquid crystal is increased. Since the blue phase appears only in a narrow temperature range, a liquid crystal composition in which a chiral material is mixed to account for several weight percent or more is used for the liquid crystal layer in order to improve the temperature range. The liquid crystal composition containing a liquid crystal exhibiting a blue phase and a chiral material has a short response time and optical isotropy, which eliminates the need for an alignment process. An alignment film does not need to be provided, and thus, rubbing treatment is not necessary; accordingly, electrostatic discharge damage caused by the rubbing treatment can be prevented, and defects and damage of a liquid crystal display device in the manufacturing process can be reduced. Moreover, the liquid crystal material that exhibits a blue phase has small viewing angle dependence.

In the case where a liquid crystal element is used as a display element, a twisted nematic (TN) mode, an in-plane switching (IPS) mode, a fringe field switching (FFS) mode, an axially symmetric aligned micro-cell (ASM) mode, an optical compensated birefringence (OCB) mode, a ferroelectric liquid crystal (FLC) mode, an anti-ferroelectric liquid crystal (AFLC) mode, or the like can be used.

Furthermore, a normally black liquid crystal display device such as a vertical alignment (VA) mode transmissive liquid crystal display device may also be used. There are some examples of a vertical alignment mode; for example, a multi-domain vertical alignment (MVA) mode, a patterned vertical alignment (PVA) mode, and an ASV mode, or the like can be employed.

The touch pen of one embodiment of the present invention can be used together with the touch panel provided in the above-described display device. The ball 107 in the touch pen rolls in accordance with the move of the touch pen without slipping on the surface of the touch panel or display device. By moving the touch pen on the surface of the touch panel or display device, with the ball 107 in the touch pen rolling on the surface, input can be provided to the display device. Using the touch pen of one embodiment of the present invention, a user can provide input to the display device feeling as if he/she is drawing with a writing instrument on a piece of paper. Furthermore, with use of the touch pen of one embodiment of the present invention, input to the display device without scratching or damaging the surface of the touch panel or display device is possible.

### <3-8. Components>

The above components will be described below.

### [Substrate]

A material having a flat surface can be used as the substrate included in the display panel. The substrate on the side from which light from the display element is extracted is formed using a material transmitting the light. For example, a material such as glass, quartz, ceramic, sapphire, or an organic resin can be used.

The weight and thickness of the display panel can be decreased by using a thin substrate. A flexible display panel can be obtained by using a substrate that is thin enough to have flexibility.

Since the substrate through which light emission is not extracted does not need to have a light-transmitting property, a metal substrate or the like can be used in addition to the above-mentioned substrates. A metal substrate, which has high thermal conductivity, is preferable because it can easily conduct heat to the whole substrate and accordingly can prevent a local temperature rise in the display panel. To obtain flexibility and bendability, the thickness of a metal substrate is preferably greater than or equal to 10 μm and less than or equal to 200 μm, further preferably greater than or equal to 20 μm and less than or equal to 50 μm.

There is no particular limitation on a material of a metal substrate. A metal such as aluminum, copper, or nickel, an aluminum alloy, or an alloy such as stainless steel can be suitably used, for example.

A substrate subjected to insulation treatment, e.g., a metal substrate whose surface is oxidized or provided with an insulating film may be used. The insulating film may be formed by, for example, a coating method such as a spin-coating method or a dipping method, an electrodeposition method, an evaporation method, or a sputtering method. An oxide film may be formed on the substrate surface by exposure to or heating in an oxygen atmosphere or by an anodic oxidation method or the like.

Examples of the material that has flexibility and transmits visible light include polyester resins such as polyethylene terephthalate (PET) and polyethylene naphthalate (PEN), a polyacrylonitrile resin, a polyimide resin, a polymethyl methacrylate resin, a polycarbonate (PC) resin, a polyethersulfone (PES) resin, a polyamide resin, a cycloolefin resin, a polystyrene resin, a polyamide imide resin, a polyvinyl chloride resin, and a polytetrafluoroethylene (PTFE). It is particularly preferable to use a material with a low thermal expansion coefficient, for example, a material with a thermal expansion coefficient lower than or equal to 30×10⁻⁶/K, such as a polyamide imide resin, a polyimide resin, or PET. A substrate in which a glass fiber is impregnated with an organic resin or a substrate whose thermal expansion coefficient is reduced by mixing an inorganic filler with an organic resin can also be used. A substrate using such a material is lightweight, and thus a display panel using this substrate can also be lightweight.

In the case where a fibrous body is included in the above material, a high-strength fiber of an organic compound or an inorganic compound is used as the fibrous body. The high-strength fiber is specifically a fiber with a high tensile elastic modulus or a fiber with a high Young's modulus. Typical examples thereof include a polyvinyl alcohol based fiber, a polyester based fiber, a polyamide based fiber, a polyethylene based fiber, an aramid based fiber, a polyparaphenylene benzobisoxazole fiber, a glass fiber, and a carbon fiber. As the glass fiber, a glass fiber using E glass, S glass, D glass, Q glass, or the like can be used. These fibers may be used in a state of a woven or nonwoven fabric, and a structure body in which this fibrous body is impregnated with a resin and the resin is cured may be used as the flexible substrate. The structure body including the fibrous body and the resin is preferably used as the flexible substrate, in which case the reliability against breaking due to bending or local pressure can be increased.

Alternatively, glass, metal, or the like that is thin enough to have flexibility can be used as the substrate. Alternatively, a composite material in which glass and resin material are attached to each other with an adhesive layer may be used.

A hard coat layer (e.g., a silicon nitride layer and an aluminum oxide layer) by which a surface of a display panel is protected from damage, a layer (e.g., an aramid resin layer) that can disperse pressure, or the like may be stacked over the flexible substrate. Furthermore, to suppress a decrease in lifetime of the display element due to moisture and the like, an insulating film with low water permeability may be stacked over the flexible substrate. For example, an inorganic insulating material such as silicon nitride, silicon oxynitride, silicon nitride oxide, aluminum oxide, or aluminum nitride can be used.

The substrate may be formed by stacking a plurality of layers. When a glass layer is included, a barrier property against water and oxygen can be improved and thus a highly reliable display panel can be provided.

### [Transistor]

The transistor includes a conductive layer serving as a gate electrode, a semiconductor layer, a conductive layer serving as a source electrode, a conductive layer serving as a drain electrode, and an insulating layer serving as a gate insulating layer. In the above, a bottom-gate transistor is used.

Note that there is no particular limitation on the structure of the transistor included in the display device of one embodiment of the present invention. For example, a planar transistor, a staggered transistor, or an inverted staggered transistor may be used. A top-gate transistor or a bottom-gate transistor may be used. Gate electrodes may be provided above and below a channel.

There is no particular limitation on the crystallinity of a semiconductor material used for the transistors, and an amorphous semiconductor or a semiconductor having crystallinity (a microcrystalline semiconductor, a polycrystalline semiconductor, a single-crystal semiconductor, or a semiconductor partly including crystal regions) may be used. It is preferable that a semiconductor having crystallinity be used, in which case deterioration of the transistor characteristics can be suppressed.

As a semiconductor material used for the transistors, a metal oxide whose energy gap is greater than or equal to 2 eV, preferably greater than or equal to 2.5 eV, further preferably greater than or equal to 3 eV can be used. A typical example thereof is an oxide semiconductor containing indium, and for example, a CAC-OS described later or the like can be used.

A transistor with an oxide semiconductor having a larger band gap and a lower carrier density than silicon has a low off-state current, and thus, charges stored in a capacitor that is series-connected to the transistor can be held for a long time.

The semiconductor layer can be, for example, a film represented by an In-M-Zn-based oxide that contains at least indium, zinc, and M (a metal such as aluminum, titanium, gallium, germanium, yttrium, zirconium, lanthanum, cerium, tin, neodymium, or hafnium).

In the case where the oxide semiconductor contained in the semiconductor layer contains an In-M-Zn-based oxide, it is preferable that the atomic ratio of metal elements of a sputtering target used for forming a film of the In-M-Zn oxide satisfy In≧M and Zn≧M. The atomic ratio of metal elements in such a sputtering target is preferably, for example, In:M:Zn=1:1:1, In:M:Zn=1:1:1.2, In:M:Zn=3:1:2, In:M:Zn=4:2:3, In:M:Zn=4:2:4.1, In:M:Zn=5:1:6, In:M:Zn=5:1:7, or In:M:Zn=5:1:8. Note that the atomic ratio of metal elements in the formed oxide semiconductor layer varies from the above atomic ratios of metal elements of the sputtering targets in a range of ±40%.

The bottom-gate transistor described in this embodiment is preferable because the number of manufacturing steps can be reduced. When an oxide semiconductor, which can be formed at a lower temperature than polycrystalline silicon, is used, materials with low heat resistance can be used for a wiring, an electrode, or a substrate below the semiconductor layer, so that the range of choices of materials can be widened. For example, an extremely large glass substrate can be suitably used.

An oxide semiconductor film with low carrier density is used as the semiconductor layer. For example, the semiconductor layer may be an oxide semiconductor whose carrier density is lower than or equal to 1×10¹⁷/cm³, preferably lower than or equal to 1×10¹⁵/cm³, further preferably lower than or equal to 1×10¹³/cm³, still further preferably lower than or equal to 1×10¹¹/cm³, even further preferably lower than 1×10¹⁰/cm³, and higher than or equal to 1×10⁻⁹/cm³. Such an oxide semiconductor is referred to as a highly purified intrinsic or substantially highly purified intrinsic oxide semiconductor. The oxide semiconductor has a low impurity concentration and a low density of defect states, and thus can be said to have stable characteristics.

Note that, without limitation to those described above, a material with an appropriate composition may be used in accordance with required semiconductor characteristics and electrical characteristics (e.g., field-effect mobility and threshold voltage) of a transistor. To obtain the required semiconductor characteristics of the transistor, it is preferable that the carrier density, the impurity concentration, the defect density, the atomic ratio between a metal element and oxygen, the interatomic distance, the density, and the like of the semiconductor layer be set to appropriate values.

When silicon or carbon that is an element belonging to Group 14 is contained in the oxide semiconductor contained in the semiconductor layer, oxygen vacancies are increased in the semiconductor layer, and the semiconductor layer becomes n-type. Thus, the concentration of silicon or carbon (measured by secondary ion mass spectrometry) in the semiconductor layer is set to lower than or equal to 2×10¹⁸ atoms/cm³, preferably lower than or equal to 2×10¹⁷ atoms/cm³.

Alkali metal and alkaline earth metal might generate carriers when bonded to an oxide semiconductor, in which case the off-state current of the transistor might be increased. Thus, the concentration of alkali metal or alkaline earth metal in the semiconductor layer, which is measured by secondary ion mass spectrometry, is set to lower than or equal to 1×10¹⁸ atoms/cm³, preferably lower than or equal to 2×10¹⁶ atoms/cm³.

When nitrogen is contained in the oxide semiconductor contained in the semiconductor layer, electrons serving as carriers are generated and the carrier density increases, so that the semiconductor layer easily becomes n-type. Thus, a transistor including an oxide semiconductor that contains nitrogen is likely to be normally on. Hence, the concentration of nitrogen in the semiconductor layer, which is measured by secondary ion mass spectrometry, is preferably set to lower than or equal to 5×10¹⁸ atoms/cm³.

The semiconductor layer may have a non-single-crystal structure, for example. The non-single-crystal structure includes CAAC-OS (c-axis aligned crystalline oxide semiconductor, or c-axis aligned a-b-plane-anchored crystalline oxide semiconductor) including a c-axis aligned crystal, a polycrystalline structure, a microcrystalline structure, or an amorphous structure, for example. Among the non-single-crystal structures, an amorphous structure has the highest density of defect states, whereas CAAC-OS has the lowest density of defect states.

An oxide semiconductor film having an amorphous structure has disordered atomic arrangement and no crystalline component, for example. In another example, an oxide film having an amorphous structure has an absolutely amorphous structure and no crystal part.

Note that the semiconductor layer may be a mixed film including two or more of the following: a region having an amorphous structure, a region having a microcrystalline structure, a region having a polycrystalline structure, a region of CAAC-OS, and a region having a single-crystal structure. The mixed film has, for example, a single-layer structure or a stacked-layer structure including two or more of the above-described regions in some cases.

### <Composition of CAC-OS>

Described below is the composition of a cloud-aligned composite oxide semiconductor (CAC-OS) applicable to a transistor disclosed in one embodiment of the present invention.

The CAC-OS has, for example, a composition in which elements included in an oxide semiconductor are unevenly distributed. Materials including unevenly distributed elements each have a size of greater than or equal to 0.5 nm and less than or equal to 10 nm, preferably greater than or equal to 1 nm and less than or equal to 2 nm, or a similar size. Note that in the following description of an oxide semiconductor, a state in which one or more metal elements are unevenly distributed and regions including the metal element(s) are mixed is referred to as a mosaic pattern or a patch-like pattern. The region has a size of greater than or equal to 0.5 nm and less than or equal to 10 nm, preferably greater than or equal to 1 nm and less than or equal to 2 nm, or a similar size.

Note that an oxide semiconductor preferably contains at least indium. In particular, indium and zinc are preferably contained. In addition, one or more of aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

For example, of the CAC-OS, an In—Ga—Zn oxide with the CAC composition (such an In—Ga—Zn oxide may be particularly referred to as CAC-IGZO) has a composition in which materials are separated into indium oxide (InO_{X1}, where X1 is a real number greater than 0) or indium zinc oxide (In_{X2}Zn_{Y2}O_{Z2}, where X2, Y2, and Z2 are real numbers greater than 0), and gallium oxide (GaO_{X3}, where X3 is a real number greater than 0) or gallium zinc oxide (Ga_{X4}Zn_{Y4}O_{Z4}, where X4, Y4, and Z4 are real numbers greater than 0), and a mosaic pattern is formed. Then, InO_{X1} or In_{X2}Zn_{Y2}O_{Z2} forming the mosaic pattern is evenly distributed in the film. This composition is also referred to as a cloud-like composition.

That is, the CAC-OS is a composite oxide semiconductor with a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is greater than the atomic ratio of In to an element M in a second region, the first region has higher In concentration than the second region.

Note that a compound including In, Ga, Zn, and O is also known as IGZO. Typical examples of IGZO include a crystalline compound represented by InGaO₃(ZnO)ₘ₁ (m1 is a natural number) and a crystalline compound represented by In₍₁₋ₓ₀₎Pa₍₁₋ₓ₀₎O₃(ZnO)ₘ₀ (−1≦x0≦1; m0 is a given number).

The above crystalline compounds have a single crystal structure, a polycrystalline structure, or a CAAC structure. Note that the CAAC structure is a crystal structure in which a plurality of IGZO nanocrystals have c-axis alignment and are connected in the a-b plane direction without alignment.

The CAC-OS relates to the material composition of an oxide semiconductor. In a material composition of a CAC-OS including In, Ga, Zn, and O, regions where nanoparticles including Ga as a main component are partly observed and regions where nanoparticles including In as a main component are partly observed are randomly dispersed to form a mosaic pattern. Thus, the crystal structure is a secondary element for the CAC-OS composition.

Note that in the CAC-OS, a stacked-layer structure including two or more films with different atomic ratios is not included. For example, a two-layer structure of a film including In as a main component and a film including Ga as a main component is not included.

A boundary between the region including GaO₃ as a main component and the region including In_{X2}Zn_{Y2}O_{Z2} or InO_{X1} as a main component is not clearly observed in some cases.

In the case where one or more of aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium in a CAC-OS, regions where nanoparticles including the metal element(s) as a main component(s) are partly observed and regions where nanoparticles including In as a main component are partly observed are randomly dispersed to form a mosaic pattern in the CAC-OS.

The CAC-OS can be formed by a sputtering method under a condition where a substrate is not intentionally heated, for example. In the case where the CAC-OS is formed by a sputtering method, one or more of an inert gas (typically, argon), an oxygen gas, and a nitrogen gas may be used as a deposition gas. The flow rate of the oxygen gas to the total flow rate of the deposition gas in deposition is preferably as low as possible, for example, the flow rate of the oxygen gas is higher than or equal to 0% and lower than 30%, preferably higher than or equal to 0% and lower than or equal to 10%.

The CAC-OS is characterized in that a clear peak is not observed when measurement is conducted using a θ/2θ scan by an out-of-plane method, which is an X-ray diffraction (XRD) method. That is, X-ray diffraction shows no alignment in the a-b plane direction and the c-axis direction in a measured region.

In the CAC-OS, an electron diffraction pattern that is obtained by irradiation with an electron beam with a probe diameter of 1 nm (also referred to as nanobeam electron beam) has regions with high luminance in a ring pattern and a plurality of bright spots appear in the ring-like pattern. Thus, the electron diffraction pattern indicates that the crystal structure of the CAC-OS includes a nanocrystal (nc) structure with no alignment in plan-view and cross-sectional directions.

For example, an energy dispersive X-ray spectroscopy (EDX) mapping image indicates that an In—Ga—Zn oxide with the CAC composition has a structure in which a region including GaO as a main component and a region including In_{X2}Zn_{Y2}O_{Z2} or InO_{X1} as a main component are unevenly distributed and mixed.

The CAC-OS has a structure different from that of an IGZO compound in which metal elements are evenly distributed, and has characteristics different from those of the IGZO compound. That is, in the CAC-OS, regions including GaO_{X3} or the like as a main component and regions including In_{X2}Zn_{Y2}O_{Z2} or InO_{X1} as a main component are separated to form a mosaic pattern.

The conductivity of a region including In_{X2}Zn_{Y2}O_{Z2} or InO_{X1} as a main component is higher than that of a region including GaO_{X3} or the like as a main component. In other words, when carriers flow through regions including In_{X2}Zn_{Y2}O_{Z2} or InO_{X1} as a main component, the conductivity of an oxide semiconductor is exhibited. Accordingly, when regions including In_{X2}Zn_{Y2}O_{Z2} or InO_{X1} as a main component are distributed in an oxide semiconductor like a cloud, high field-effect mobility (μ) can be achieved.

In contrast, the insulating property of a region including GaO₃ or the like as a main component is higher than that of a region including In_{X2}Zn_{Y2}O_{Z2} or InO_{X1} as a main component. In other words, when regions including GaO_{X3} or the like as a main component are distributed in an oxide semiconductor, leakage current can be suppressed and favorable switching operation can be achieved.

Accordingly, when a CAC-OS is used for a semiconductor element, the insulating property derived from GaO_{X3} or the like and the conductivity derived from In_{X2}Zn_{Y2}O_{Z2} or InO_{X1} complement each other, whereby high on-state current (Iₒₙ) and high field-effect mobility (μ) can be achieved.

A semiconductor element including a CAC-OS has high reliability. Thus, the CAC-OS is suitably used in a variety of semiconductor devices typified by a display.

Alternatively, silicon may be used as a semiconductor in which a channel of a transistor is formed. Although amorphous silicon may be used as silicon, silicon having crystallinity is particularly preferable. For example, microcrystalline silicon, polycrystalline silicon, single crystal silicon, or the like is preferably used. In particular, polycrystalline silicon can be formed at a lower temperature than single crystal silicon and has higher field effect mobility and higher reliability than amorphous silicon.

The bottom-gate transistor described in this embodiment is preferable because the number of manufacturing steps can be reduced. When amorphous silicon, which can be formed at a lower temperature than polycrystalline silicon, is used for the semiconductor layer, materials with low heat resistance can be used for a wiring, an electrode, or a substrate below the semiconductor layer, resulting in wider choice of materials. For example, an extremely large glass substrate can be suitably used. Meanwhile, the top-gate transistor is preferable because an impurity region is easily formed in a self-aligned manner and variation in characteristics and the like can be reduced. The top-gate transistor is particularly preferable when polycrystalline silicon, single-crystal silicon, or the like is employed.

### [Conductive Layer]

As materials for conductive layers such as wirings and electrodes included in a display device, a gate, a source, and a drain of a transistor; any of metals such as aluminum, titanium, chromium, nickel, copper, yttrium, zirconium, molybdenum, silver, tantalum, and tungsten, or an alloy containing any of these metals as its main component can be used. A single-layer structure or multi-layer structure including a film containing any of these materials can be used. For example, the following structures can be given: a single-layer structure of an aluminum film containing silicon, a two-layer structure in which an aluminum film is stacked over a titanium film, a two-layer structure in which an aluminum film is stacked over a tungsten film, a two-layer structure in which a copper film is stacked over a copper-magnesium-aluminum alloy film, a two-layer structure in which a copper film is stacked over a titanium film, a two-layer structure in which a copper film is stacked over a tungsten film, a three-layer structure in which a titanium film or a titanium nitride film, an aluminum film or a copper film, and a titanium film or a titanium nitride film are stacked in this order, and a three-layer structure in which a molybdenum film or a molybdenum nitride film, an aluminum film or a copper film, and a molybdenum film or a molybdenum nitride film are stacked in this order. Note that an oxide such as indium oxide, tin oxide, or zinc oxide may be used. Copper containing manganese is preferably used because the controllability of a shape by etching is increased.

As a light-transmitting conductive material, a conductive oxide such as indium oxide, indium tin oxide, indium zinc oxide, zinc oxide, or zinc oxide to which gallium is added, or graphene can be used. Alternatively, a metal material such as gold, silver, platinum, magnesium, nickel, tungsten, chromium, molybdenum, iron, cobalt, copper, palladium, or titanium, or an alloy material containing any of these metal materials can be used. Alternatively, a nitride of the metal material (e.g., titanium nitride) or the like may be used. In the case where the metal material or the alloy material (or the nitride thereof) is used, the thickness is set small enough to allow light transmission. Alternatively, a stack of any of the above materials can be used as the conductive layer. For example, a stacked film of indium tin oxide and an alloy of silver and magnesium is preferably used because the conductivity can be increased. They can be used for conductive layers such as a variety of wirings and electrodes included in a display device, and conductive layers (e.g., conductive layers serving as a pixel electrode or a common electrode) included in a display element.

### [Insulating Layer]

Examples of an insulating material that can be used for the insulating layers include a resin such as acrylic or epoxy resin, a resin having a siloxane bond such as silicone, and an inorganic insulating material such as silicon oxide, silicon oxynitride, silicon nitride oxide, silicon nitride, or aluminum oxide.

The light-emitting element is preferably provided between a pair of insulating films with low water permeability, in which case impurities such as water can be prevented from entering the light-emitting element, thereby preventing a decrease in the reliability of the device.

As an insulating film with low water permeability, a film containing nitrogen and silicon (e.g., a silicon nitride film or a silicon nitride oxide film), a film containing nitrogen and aluminum (e.g., an aluminum nitride film), or the like can be used. A silicon oxide film, a silicon oxynitride film, an aluminum oxide film, or the like may also be used.

The water vapor transmittance of the insulating film with low water permeability is, for example, lower than or equal to 1×10⁻⁵ [g/(m²·day)], preferably lower than or equal to 1×10⁻⁶ [g/(m²·day)], further preferably lower than or equal to 1×10⁻⁷ [g/(m²·day)], and still further preferably lower than or equal to 1×10⁻⁸ [g/(m²·day)].

### [Liquid Crystal Element]

The liquid crystal element can employ, for example, a vertical alignment (VA) mode. Examples of the vertical alignment mode include a multi-domain vertical alignment (MVA) mode, a patterned vertical alignment (PVA) mode, and an advanced super view (ASV) mode.

The liquid crystal element can employ a variety of modes; for example, other than the VA mode, a twisted nematic (TN) mode, an in-plane switching (IPS) mode, a fringe field switching (FFS) mode, an axially symmetric aligned micro-cell (ASM) mode, an optically compensated birefringence (OCB) mode, a ferroelectric liquid crystal (FLC) mode, or an antiferroelectric liquid crystal (AFLC) mode can be used.

The liquid crystal element controls the transmission or non-transmission of light by utilizing an optical modulation action of a liquid crystal. Note that the optical modulation action of the liquid crystal is controlled by an electric field applied to the liquid crystal (including a horizontal electric field, a vertical electric field, or an oblique electric field). As the liquid crystal used for the liquid crystal element, thermotropic liquid crystal, low-molecular liquid crystal, high-molecular liquid crystal, polymer dispersed liquid crystal (PDLC), ferroelectric liquid crystal, anti-ferroelectric liquid crystal, or the like can be used. These liquid crystal materials exhibit a cholesteric phase, a smectic phase, a cubic phase, a chiral nematic phase, an isotropic phase, or the like depending on conditions.

As the liquid crystal material, either a positive liquid crystal or a negative liquid crystal may be used, and an appropriate liquid crystal material can be used in accordance with the mode or design to be used.

An alignment film can be provided to adjust the alignment of a liquid crystal. In the case where a horizontal electric field mode is employed, a liquid crystal exhibiting a blue phase for which an alignment film is unnecessary may be used. The blue phase is a liquid crystal phase, which is generated just before a cholesteric phase changes into an isotropic phase when the temperature of a cholesteric liquid crystal is increased. Since the blue phase appears only in a narrow temperature range, a liquid crystal composition in which a chiral material is mixed to account for several weight percent or more is used for the liquid crystal layer in order to improve the temperature range. The liquid crystal composition containing a liquid crystal exhibiting a blue phase and a chiral material has a short response time and optical isotropy, which eliminates the need for an alignment process and reduces the viewing angle dependence. Since the alignment film does not need to be provided, rubbing treatment is not necessary; accordingly, electrostatic discharge damage caused by the rubbing treatment can be prevented, reducing defects and damage of a liquid crystal display device in the manufacturing process.

The liquid crystal element may be a transmissive liquid crystal element, a reflective liquid crystal element, a transflective liquid crystal element, or the like.

### [Light-Emitting Element]

As the light-emitting element, a self-luminous element can be used, and an element whose luminance is controlled by current or voltage is included in the category of the light-emitting element. For example, an LED, an organic EL element, an inorganic EL element, or the like can be used.

The light-emitting element has a top emission structure, a bottom emission structure, a dual emission structure, or the like. A conductive film that transmits visible light is used as the electrode through which light is extracted. A conductive film that reflects visible light is preferably used as the electrode through which light is not extracted.

The EL layer includes at least a light-emitting layer. In addition to the light-emitting layer, the EL layer may further include one or more layers containing any of a substance with a high hole-injection property, a substance with a high hole-transport property, a hole-blocking material, a substance with a high electron-transport property, a substance with a high electron-injection property, a substance with a bipolar property (a substance with a high electron- and hole-transport property), and the like.

For the EL layer, either a low-molecular compound or a high-molecular compound can be used, and an inorganic compound may also be used. Each of the layers included in the EL layer can be formed by any of the following methods: an evaporation method (including a vacuum evaporation method), a transfer method, a printing method, an inkjet method, a coating method, and the like.

When a voltage higher than the threshold voltage of the light-emitting element is applied between a cathode and an anode, holes are injected to the EL layer from the anode side and electrons are injected to the EL layer from the cathode side. The injected electrons and holes are recombined in the EL layer and a light-emitting substance contained in the EL layer emits light.

In the case where a light-emitting element emitting white light is used as the light-emitting element, the EL layer preferably contains two or more kinds of light-emitting substances. For example, the two or more kinds of light-emitting substances are selected so as to emit light of complementary colors to obtain white light emission. Specifically, it is preferable to contain two or more selected from light-emitting substances emitting light of red (R), green (G), blue (B), yellow (Y), orange (0), and the like and light-emitting substances emitting light containing two or more of spectral components of R, G, and B. The light-emitting element preferably emits light with a spectrum having two or more peaks in the wavelength range of a visible light region (e.g., 350 nm to 750 nm). An emission spectrum of a material emitting light having a peak in a yellow wavelength range preferably includes spectral components also in green and red wavelength ranges.

A light-emitting layer containing a light-emitting material emitting light of one color and a light-emitting layer containing a light-emitting material emitting light of another color are preferably stacked in the EL layer. The plurality of light-emitting layers in the EL layer may be stacked in contact with each other or may be stacked with a region not including any light-emitting material therebetween, for example. Specifically, between a fluorescent layer and a phosphorescent layer, a region containing the same material as one in the fluorescent layer or the phosphorescent layer (e.g., a host material or an assist material) and no light-emitting material may be provided, for example. This facilitates the manufacture of the light-emitting element and reduces the drive voltage.

The light-emitting element may be a single element including one EL layer or a tandem element in which a plurality of EL layers are stacked with a charge generation layer therebetween.

The conductive film that transmits visible light can be formed using, for example, indium oxide, indium tin oxide, indium zinc oxide, zinc oxide, or zinc oxide to which gallium is added. Alternatively, a film of a metal material such as gold, silver, platinum, magnesium, nickel, tungsten, chromium, molybdenum, iron, cobalt, copper, palladium, or titanium; an alloy containing any of these metal materials; or a nitride of any of these metal materials (e.g., titanium nitride) can be formed thin so as to have a light-transmitting property. Alternatively, a stacked film of any of the above materials can be used for the conductive layers. For example, a stacked film of indium tin oxide and an alloy of silver and magnesium is preferably used, in which case conductivity can be increased. Further alternatively, graphene or the like may be used.

For the conductive film that reflects visible light, for example, a metal material such as aluminum, gold, platinum, silver, nickel, tungsten, chromium, molybdenum, iron, cobalt, copper, or palladium or an alloy containing any of these metal materials can be used. Furthermore, lanthanum, neodymium, germanium, or the like may be added to the metal material or the alloy. Alternatively, an alloy containing aluminum (an aluminum alloy) such as an alloy of aluminum and titanium, an alloy of aluminum and nickel, or an alloy of aluminum and neodymium may be used. Alternatively, an alloy containing silver such as an alloy of silver and copper, an alloy of silver and palladium, or an alloy of silver and magnesium may be used. An alloy containing silver and copper is preferable because of its high heat resistance. Furthermore, when a metal film or a metal oxide film is stacked in contact with an aluminum film or an aluminum alloy film, oxidation can be suppressed. Examples of a material for the metal film or the metal oxide film include titanium and titanium oxide. Alternatively, the above conductive film that transmits visible light and a film containing a metal material may be stacked. For example, a stack of silver and indium tin oxide, a stack of an alloy of silver and magnesium and indium tin oxide, or the like can be used.

Each of the electrodes can be formed by an evaporation method or a sputtering method. Alternatively, a discharging method such as an inkjet method, a printing method such as a screen printing method, or a plating method may be used.

Note that the aforementioned light-emitting layer and layers containing a substance with a high hole-injection property, a substance with a high hole-transport property, a substance with a high electron-transport property, a substance with a high electron-injection property, and a substance with a bipolar property may include an inorganic compound such as a quantum dot or a high molecular compound (e.g., an oligomer, a dendrimer, or a polymer). For example, used for the light-emitting layer, the quantum dot can serve as a light-emitting material.

The quantum dot may be a colloidal quantum dot, an alloyed quantum dot, a core-shell quantum dot, a core quantum dot, or the like. The quantum dot containing elements belonging to Groups 12 and 16, elements belonging to Groups 13 and 15, or elements belonging to Groups 14 and 16, may be used. Alternatively, the quantum dot containing an element such as cadmium, selenium, zinc, sulfur, phosphorus, indium, tellurium, lead, gallium, arsenic, or aluminum may be used.

### [Coloring Layer]

Examples of a material that can be used for the coloring layers include a metal material, a resin material, and a resin material containing a pigment or dye.

### [Light-Blocking Layer]

Examples of a material that can be used for the light-blocking layer include carbon black, titanium black, a metal, a metal oxide, and a composite oxide containing a solid solution of a plurality of metal oxides. The light-blocking layer may be a film containing a resin material or a thin film of an inorganic material such as a metal. Stacked films containing the material of the coloring layer can also be used for the light-blocking layer. For example, a stacked-layer structure of a film containing a material of a coloring layer that transmits light of a certain color and a film containing a material of a coloring layer that transmits light of another color can be employed. It is preferable that the coloring layer and the light-blocking layer be formed using the same material because the same manufacturing apparatus can be used and the process can be simplified.

The above is the description of each of the components.

At least part of this embodiment can be implemented in combination with any of the other embodiments described in this specification as appropriate.

### Embodiment 4

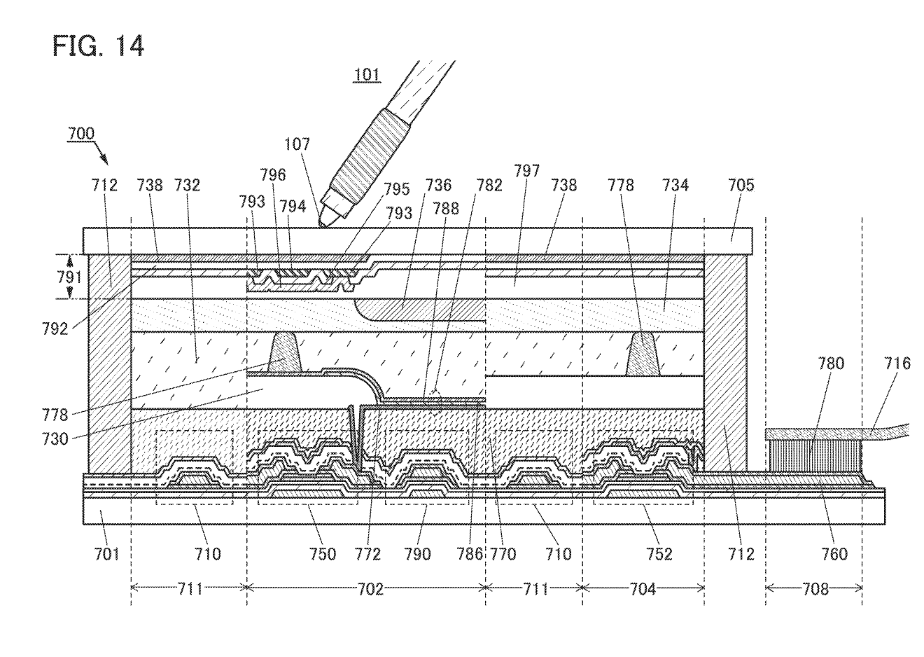

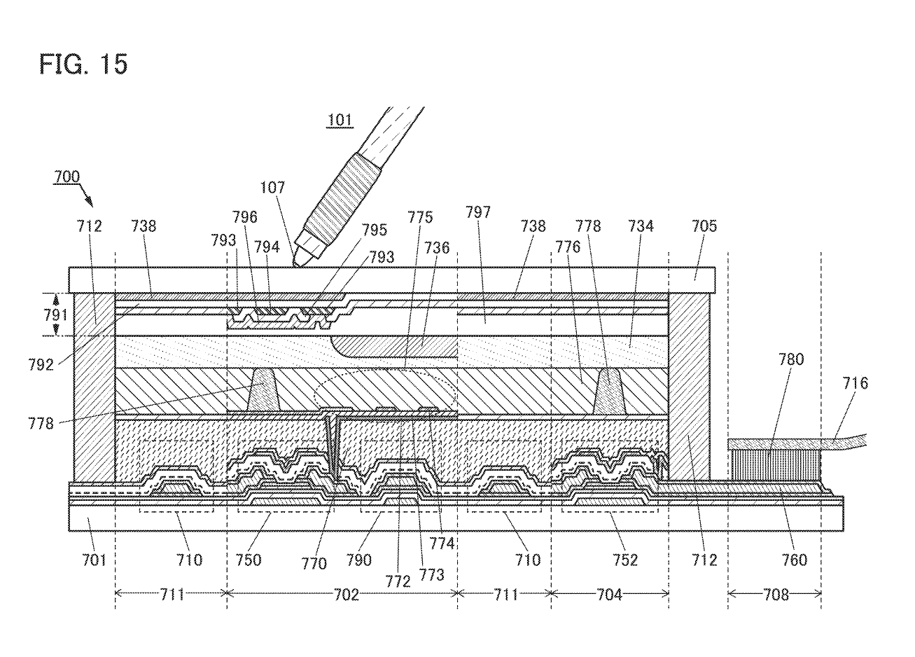

In this embodiment, a display device in which a touch sensor is incorporated (i.e., an in-cell display device) will be described as another example of an electronic device to which input is provided using the touch pen of one embodiment of the present invention. FIG. 14 illustrates an EL display device with an in-cell touch sensor. FIG. 15 illustrates a liquid crystal display device with an in-cell touch sensor. Note that description that overlaps with the description of FIG. 12 and FIG. 13 in Embodiment 3 will be omitted.

In the display device 700 illustrated in FIG. 14 and FIG. 15, a touch sensor 791 as an input/output device is provided.

The touch sensor 791 illustrated in FIG. 14 and FIG. 15 is what we call an in-cell touch sensor provided between the second substrate 705 and the coloring layer 736. Although the touch sensor 791 in FIG. 14 and FIG. 15 is formed between the light-blocking layer 738 and the coloring layer 736, this embodiment is not limited thereto. Another light-blocking layer may be provided between the touch sensor 791 and the coloring layer 736, or the light-blocking layer 738 may be provided between the touch sensor 791 and the coloring layer 736.

The touch sensor 791 includes the light-blocking layer 738, an insulating film 792, an electrode 793, an electrode 794, an insulating film 795, an electrode 796, and an insulating film 797. A change in the mutual capacitance between the electrode 793 and the electrode 794 can be sensed when an object such as a finger or a touch pen approaches, for example.

A portion in which the electrode 793 intersects with the electrode 794 is shown above the transistor 750 in FIG. 14 and FIG. 15. The electrode 796 is electrically connected to the two electrodes 793 between which the electrode 794 is sandwiched through openings provided in the insulating film 795. Note that a structure in which a region where the electrode 796 is provided is in the pixel portion 702 is illustrated in FIG. 14 and FIG. 15 as an example; however, one embodiment of the present invention is not limited thereto. For example, the region where the electrode 796 is provided may be in the source driver circuit portion 704.

The electrode 793 and the electrode 794 are provided in a region overlapping with the light-blocking layer 738. As illustrated in FIG. 14, it is preferable that the electrode 793 not overlap with the light-emitting element 782. As illustrated in FIG. 15, it is preferable that the electrode 793 not overlap with the liquid crystal element 775. In other words, the electrode 793 has an opening in a region overlapping with the light-emitting element 782 and the liquid crystal element 775. That is, the electrode 793 has a mesh shape. With such a structure, the electrode 793 does not block light emitted from the light-emitting element 782, or alternatively the electrode 793 does not block light transmitted through the liquid crystal element 775. Thus, since luminance is hardly reduced even when the touch sensor 791 is provided, a display device with high visibility and low power consumption can be obtained. Note that the electrode 794 can have a structure similar to that of the electrode 793.

Since the electrode 793 and the electrode 794 do not overlap with the light-emitting element 782, a metal material having low transmittance with respect to visible light can be used for the electrode 793 and the electrode 794. Furthermore, since the electrode 793 and the electrode 794 do not overlap with the liquid crystal element 775, a metal material having low transmittance with respect to visible light can be used for the electrode 793 and the electrode 794.

Thus, as compared with the case where an oxide material whose transmittance of visible light is high is used, resistance of the electrodes 793 and 794 can be reduced, whereby sensitivity of the sensor of the touch panel can be increased.

Conductive nanowires may be used for the electrodes 793, 794, and 796, for example. The nanowire may have a mean diameter of greater than or equal to 1 nm and less than or equal to 100 nm, preferably greater than or equal to 5 nm and less than or equal to 50 nm, further preferably greater than or equal to 5 nm and less than or equal to 25 nm. As the nanowire, a carbon nanotube or a metal nanowire such as an Ag nanowire, a Cu nanowire, or an Al nanowire may be used. For example, in the case where an Ag nanowire is used for any one of or each of electrodes 793, 794, and 796, the transmittance of visible light can be greater than or equal to 89% and the sheet resistance can be greater than or equal to 40 Ω/square (Ω/sq.) and less than or equal to 100 Ω/sq.

Although the structure of the in-cell touch panel is illustrated in FIG. 14 and FIG. 15, one embodiment of the present invention is not limited thereto. For example, the so-called on-cell touch panel in which a touch sensor is formed on the display device 700, or the so-called out-cell touch panel in which a touch sensor is attached to the display device 700 may be used.

The touch pen of one embodiment of the present invention can be used together with the touch panel provided in the above-described display device. The ball 107 in the touch pen 101 rolls in accordance with the move of the touch pen 101 without slipping on the surface of the touch panel or display device. By moving the touch pen 101 on the surface of the touch panel or display device, with the ball 107 in the touch pen 101 rolling on the surface, input can be provided to the display device. Using the touch pen of one embodiment of the present invention, a user can provide input to the display device feeling as if he/she is drawing with a writing instrument on a piece of paper. Furthermore, with use of the touch pen of one embodiment of the present invention, input to the display device without scratching or damaging the surface of the touch panel or display device is possible.

At least part of this embodiment can be implemented in combination with any of the other embodiments described in this specification as appropriate.

### Embodiment 5

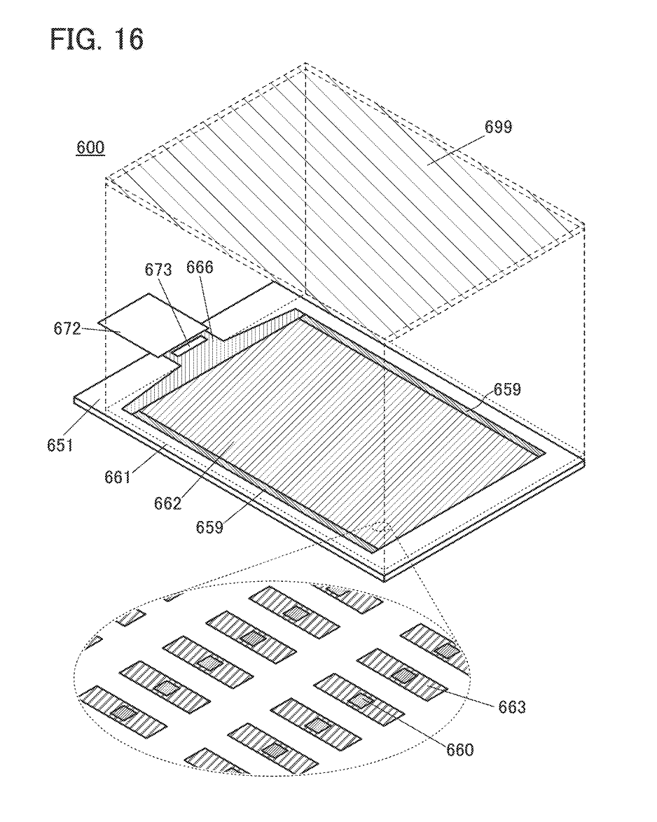

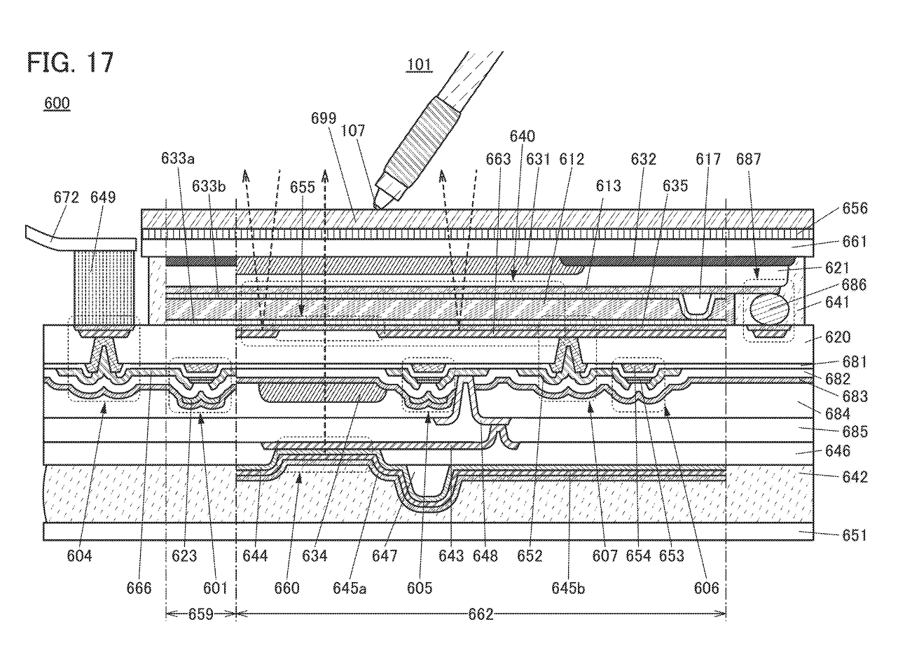

In this embodiment, an example of a display device to which input is provided using the touch pen of one embodiment of the present invention will be described with reference to FIG. 16 and FIG. 17. The display device described below includes both a reflective liquid crystal element and a light-emitting element, and is capable of displays in a transmission mode and in a reflection mode.

A reflective liquid crystal display device utilizes external light from the sun or lighting as a light source to display an image on a display panel; thus, a backlight, which is used in a transmissive liquid crystal display device, is not needed and the power consumption can be reduced. On the other hand, a reflective liquid crystal display device cannot display a clear image under conditions where sufficient external light as a light source is not obtained, such as the outdoors in a cloudy day or at night, or in a room without sufficient lighting. In contrast, a display device with a light-emitting element can display an image on a display panel even without external light because the element itself emits light, however, consumes more power for doing so. Furthermore, when external light from the sun or lighting is too intense, a clear display cannot be obtained. With use of the display panel of this embodiment, the selection between the transmission mode and the reflection mode or the combined use of the transmission mode and the reflection mode is possible in accordance with the presence or intensity of external light, so that a clear display can be obtained under any environment. Furthermore, the power consumption can be reduced.

The display device of this embodiment is suitable for long-time use or outdoor use, because it consumes less power and is capable of a clear display even outdoors with intense external light. Such features of the display device are favorable for its use as an e-book or an electronic textbook. Not only an e-book or an electronic textbook but also other such display devices are likely to be subjected to drawing/writing (input) of lines, symbols, characters, figures, pictures, or the like. At that time, the use of the touch pen of one embodiment of the present invention enables input to the display device with a comfortable writing feeling and without miswriting.

### <5-1. Structure Example of Display Panel>

FIG. 16 is a schematic perspective view illustrating a display panel 600 of one embodiment of the present invention. In the display panel 600, a substrate 651 and a substrate 661 are attached to each other. In FIG. 16, the substrate 661 is denoted by a dashed line.

The display panel 600 includes a display portion 662, a circuit 659, a wiring 666, and the like. The substrate 651 is provided with the circuit 659, the wiring 666, a conductive film 663 which serves as a pixel electrode, and the like. In FIG. 16, an IC 673 and an FPC 672 are mounted on the substrate 651. Thus, the structure illustrated in FIG. 16 can be referred to as a display module including the display panel 600, the FPC 672, and the IC 673.

A touch panel 699 is provided over the display portion 662.

As the circuit 659, for example, a circuit functioning as a scan line driver circuit can be used.

The wiring 666 has a function of supplying a signal or electric power to the display portion or the circuit 659. The signal or electric power is input to the wiring 666 from the outside through the FPC 672 or from the IC 673.

FIG. 16 shows an example in which the IC 673 is provided on the substrate 651 by a chip on glass (COG) method or the like. As the IC 673, an IC functioning as a scan line driver circuit, a signal line driver circuit, or the like can be used. Note that it is possible that the IC 673 is not provided when, for example, the display panel 600 includes circuits serving as a scan line driver circuit and a signal line driver circuit and when the circuits serving as a scan line driver circuit and a signal line driver circuit are provided outside and a signal for driving the display panel 600 is input through the FPC 672. Alternatively, the IC 673 may be mounted on the FPC 672 by a chip on film (COF) method or the like.

FIG. 16 also shows an enlarged view of part of the display portion 662. The conductive films 663 included in a plurality of display elements are arranged in a matrix in the display portion 662. The conductive film 663 has a function of reflecting visible light and serves as a reflective electrode of a liquid crystal element 640 described later.

As illustrated in FIG. 16, the conductive film 663 has an opening. A light-emitting element 660 is positioned closer to the substrate 651 than the conductive film 663 is. Light is emitted from the light-emitting element 660 to the substrate 661 side through the opening in the conductive film 663.

### <5-2. Cross-Sectional Structure Example>

FIG. 17 shows an example of cross sections of part of a region including the FPC 672, part of a region including the circuit 659, and part of a region including the display portion 662 of the display panel illustrated in FIG. 16.

The display panel includes an insulating film 620 between the substrates 651 and 661. The display panel also includes the light-emitting element 660, a transistor 601, a transistor 605, a transistor 606, a coloring layer 634, and the like between the substrate 651 and the insulating film 620. Furthermore, the display panel includes the liquid crystal element 640, a coloring layer 631, and the like between the insulating film 620 and the substrate 661. The substrate 661 and the insulating film 620 are bonded with an adhesive layer 641. The substrate 651 and the insulating film 620 are bonded with an adhesive layer 642.

The transistor 606 is electrically connected to the liquid crystal element 640 and the transistor 605 is electrically connected to the light-emitting element 660. Since the transistors 605 and 606 are formed on a surface of the insulating film 620 which is on the substrate 651 side, the transistors 605 and 606 can be formed through the same process.

The substrate 661 is provided with the coloring layer 631, a light-blocking layer 632, an insulating film 621, a conductive film 613 serving as a common electrode of the liquid crystal element 640, an alignment film 633b, an insulating film 617, and the like. The insulating film 617 serves as a spacer for holding a cell gap of the liquid crystal element 640.

Insulating layers such as an insulating film 681, an insulating film 682, an insulating film 683, an insulating film 684, and an insulating film 685 are provided on the substrate 651 side of the insulating film 620. Part of the insulating film 681 functions as a gate insulating layer of each transistor. The insulating films 682, 683, and 684 are provided to cover each transistor. The insulating film 685 is provided to cover the insulating film 684. The insulating films 684 and 685 each function as a planarization layer. Note that an example where the three insulating layers, the insulating films 682, 683, and 684, are provided to cover the transistors and the like is described here; however, one embodiment of the present invention is not limited to this example, and four or more insulating layers, a single insulating layer, or two insulating layers may be provided. The insulating film 684 functioning as a planarization layer is not necessarily provided when not needed.

The transistors 601, 605, and 606 each include a conductive film 654 part of which functions as a gate, a conductive film 652 part of which functions as a source or a drain, and a semiconductor film 653. Here, a plurality of layers obtained by processing the same conductive film are shown with the same hatching pattern.

The liquid crystal element 640 is a reflective liquid crystal element. The liquid crystal element 640 has a stacked structure of a conductive film 635, a liquid crystal layer 612, and the conductive film 613. In addition, the conductive film 663 which reflects visible light is provided in contact with the surface of the conductive film 635 that faces the substrate 651. The conductive film 663 includes an opening 655. The conductive films 635 and 613 contain a material transmitting visible light. In addition, an alignment film 633a is provided between the liquid crystal layer 612 and the conductive film 635 and the alignment film 633b is provided between the liquid crystal layer 612 and the conductive film 613. A polarizing plate 656 is provided on an outer surface of the substrate 661.

In the liquid crystal element 640, the conductive film 663 has a function of reflecting visible light and the conductive film 613 has a function of transmitting visible light. Light entering from the substrate 661 side is polarized by the polarizing plate 656, passes through the conductive film 613 and the liquid crystal layer 612, and is reflected by the conductive film 663. Then, the light passes through the liquid crystal layer 612 and the conductive film 613 again and reaches the polarizing plate 656. In this case, alignment of the liquid crystal is controlled with a voltage that is applied between the conductive film 613 and the conductive film 663, and thus optical modulation of light can be controlled. That is, the intensity of light emitted through the polarizing plate 656 can be controlled. Light excluding light in a particular wavelength region is absorbed by the coloring layer 631, and thus, emitted light is red light, for example.

The light-emitting element 660 is a bottom-emission light-emitting element. The light-emitting element 660 has a structure in which a conductive film 643, an EL layer 644, and a conductive film 645b are stacked in this order from the insulating film 620 side. In addition, a conductive film 645a is provided to cover the conductive film 645b. The conductive film 645b contains a material reflecting visible light, and the conductive films 643 and 645a contain a material transmitting visible light. Light is emitted from the light-emitting element 660 to the substrate 661 side through the coloring layer 634, the insulating film 620, the opening 655, the conductive film 613, and the like.

Here, as illustrated in FIG. 17, the conductive film 635 transmitting visible light is preferably provided for the opening 655. Accordingly, the liquid crystal layer 612 is aligned in a region overlapping with the opening 655 as well as in the other regions, in which case an alignment defect of the liquid crystal is prevented from being generated in the boundary portion of these regions and undesired light leakage can be suppressed.

As the polarizing plate 656 provided on an outer surface of the substrate 661, a linear polarizing plate or a circularly polarizing plate can be used. An example of a circularly polarizing plate is a stack including a linear polarizing plate and a quarter-wave retardation plate. Such a structure can reduce reflection of external light. The cell gap, alignment, drive voltage, and the like of the liquid crystal element used as the liquid crystal element 640 are controlled depending on the kind of the polarizing plate so that desirable contrast is obtained.

In addition, an insulating film 647 is provided on the insulating film 646 covering an end portion of the conductive film 643. The insulating film 647 has a function of a spacer for preventing the insulating film 620 and the substrate 651 from being closer than necessary. In the case where the EL layer 644 or the conductive film 645a is formed using a blocking mask (metal mask), the insulating film 647 may have a function of preventing the blocking mask from being in contact with a surface on which the EL layer 644 or the conductive film 645a is formed. Note that the insulating film 647 is not necessarily provided when not needed.

One of a source and a drain of the transistor 605 is electrically connected to the conductive film 643 of the light-emitting element 660 through a conductive film 648.

One of a source and a drain of the transistor 606 is electrically connected to the conductive film 663 through a connection portion 607. The conductive films 663 and 635 are in contact with and electrically connected to each other. Here, in the connection portion 607, the conductive layers provided on top and bottom surfaces of the insulating film 620 are connected to each other through an opening in the insulating film 620.

A connection portion 604 is provided in a region where the substrate 651 and the substrate 661 do not overlap with each other. The connection portion 604 is electrically connected to the FPC 672 through a connection layer 649. The connection portion 604 has a structure similar to that of the connection portion 607. On the top surface of the connection portion 604, a conductive layer obtained by processing the same conductive film as the conductive film 635 is exposed. Thus, the connection portion 604 and the FPC 672 can be electrically connected to each other through the connection layer 649.

A connection portion 687 is provided in part of a region where the adhesive layer 641 is provided. In the connection portion 687, the conductive layer obtained by processing the same conductive film as the conductive film 635 is electrically connected to part of the conductive film 613 with a connector 686. Accordingly, a signal or a potential input from the FPC 672 connected to the substrate 651 side can be supplied to the conductive film 613 formed on the substrate 661 side through the connection portion 687.

As the connector 686, a conductive particle can be used, for example. As the conductive particle, a particle of an organic resin, silica, or the like coated with a metal material can be used. It is preferable to use nickel or gold as the metal material because contact resistance can be reduced. It is also preferable to use a particle coated with layers of two or more kinds of metal materials, such as a particle coated with nickel and further with gold. As the connector 686, a material capable of elastic deformation or plastic deformation is preferably used. As illustrated in FIG. 17, the connector 686 which is the conductive particle has a shape that is vertically crushed in some cases. With the crushed shape, the contact area between the connector 686 and a conductive layer electrically connected to the connector 686 can be increased, thereby reducing contact resistance and suppressing the generation of problems such as disconnection.

The connector 686 is preferably provided so as to be covered with the adhesive layer 641. For example, the connectors 686 are dispersed in the adhesive layer 641 before curing.

FIG. 17 illustrates an example of the circuit 659 in which the transistor 601 is provided.

The structure in which the semiconductor film 653 where a channel is formed is provided between two gates is used as an example of the transistors 601 and 605 in FIG. 17. One gate is formed of the conductive film 654 and the other gate is formed of a conductive film 623 overlapping with the semiconductor film 653 with the insulating film 682 provided therebetween. Such a structure enables control of the threshold voltages of the transistor. In that case, the two gates may be connected to each other and supplied with the same signal to operate the transistor. Such a transistor can have higher field-effect mobility and thus have higher on-state current than other transistors. Consequently, a circuit capable of high-speed operation can be obtained. Furthermore, the area occupied by a circuit portion can be reduced. The use of the transistor having high on-state current can reduce signal delay in wirings and can reduce display unevenness even in a display panel in which the number of wirings is increased because of increase in size or resolution.

Note that the transistor included in the circuit 659 and the transistor included in the display portion 662 may have the same structure. A plurality of transistors included in the circuit 659 may have the same structure or different structures. A plurality of transistors included in the display portion 662 may have the same structure or different structures.

A material through which impurities such as water and hydrogen do not easily diffuse is preferably used for at least one of the insulating films 682 and 683 which cover the transistors. That is, the insulating film 682 or the insulating film 683 can function as a barrier film. Such a structure can effectively suppress diffusion of the impurities into the transistors from the outside, and a highly reliable display panel can be provided.

The insulating film 621 is provided on the substrate 661 side to cover the coloring layer 631 and the light-blocking layer 632. The insulating film 621 may have a function as a planarization layer. The insulating film 621 enables the conductive film 613 to have an almost flat surface, resulting in a uniform alignment state in the liquid crystal layer 612.

An example of the method for manufacturing the display panel 600 is described. For example, the conductive film 635, the conductive film 663, and the insulating film 620 are formed in order over a support substrate provided with a separation layer, and the transistor 605, the transistor 606, the light-emitting element 660, and the like are formed. Then, the substrate 651 and the support substrate are bonded with the adhesive layer 642. After that, separation is performed at the interface between the separation layer and each of the insulating film 620 and the conductive film 635, whereby the support substrate and the separation layer are removed. Separately, the coloring layer 631, the light-blocking layer 632, the conductive film 613, and the like are formed over the substrate 661 in advance. Then, a liquid crystal to form the liquid crystal layer 612 is dropped onto the substrate 651 or 661 and the substrates 651 and 661 are bonded with the adhesive layer 641, whereby the display panel 600 can be manufactured.

A material for the separation layer can be selected such that separation at the interface with each of the insulating film 620 and the conductive film 635 occurs. In particular, it is preferable that a stacked layer of a layer including a high-melting-point metal material, such as tungsten, and a layer including an oxide of the metal material be used as the separation layer, and a stacked layer of a plurality of layers, such as a silicon nitride layer, a silicon oxynitride layer, and a silicon nitride oxide layer be used as the insulating film 620 over the separation layer. The use of the high-melting-point metal material for the separation layer can increase the formation temperature of a layer formed in a later step, which reduces impurity concentration and achieves a highly reliable display panel.

As the separation layer, an oxide or a nitride such as a metal oxide, a metal nitride, or an oxide semiconductor whose resistance is reduced is preferably used. In the case where an oxide semiconductor is used, a material in which at least one of the concentrations of hydrogen, boron, phosphorus, nitrogen, and other impurities and the number of oxygen vacancies is made to be higher than those in a semiconductor layer of a transistor is used for the separation layer.

### <5-3. Components>

The above components will be described below. Note that the description of structures having functions similar to those in the above embodiments is omitted.

### [Liquid Crystal Element]

Liquid crystal elements are described in the previous embodiment. In one embodiment of the present invention, a reflective liquid crystal element in particular can be used.

In the case where a reflective liquid crystal element is used, a polarizing plate is provided on a display surface. In addition, a light diffusion plate is preferably provided on the display surface to improve visibility.

In the case where a reflective liquid crystal element is used, a front light may be provided outside the polarizing plate. As the front light, an edge-light front light is preferably used. A front light including a light-emitting diode (LED) is preferably used to reduce power consumption.

### [Adhesive Layer]

As the adhesive layer, a variety of curable adhesives such as a reactive curable adhesive, a thermosetting adhesive, an anaerobic adhesive, and a photocurable adhesive such as an ultraviolet curable adhesive can be used. Examples of these adhesives include an epoxy resin, an acrylic resin, a silicone resin, a phenol resin, a polyimide resin, an imide resin, a polyvinyl chloride (PVC) resin, a polyvinyl butyral (PVB) resin, and an ethylene vinyl acetate (EVA) resin. In particular, a material with low moisture permeability, such as an epoxy resin, is preferred. Alternatively, a two-component-mixture-type resin may be used. Further alternatively, an adhesive sheet or the like may be used.

Furthermore, the resin may include a drying agent. For example, a substance that adsorbs moisture by chemical adsorption, such as an oxide of an alkaline earth metal (e.g., calcium oxide or barium oxide), can be used. Alternatively, a substance that adsorbs moisture by physical adsorption, such as zeolite or silica gel, may be used. The drying agent is preferably included because it can prevent impurities such as moisture from entering the element, thereby improving the reliability of the display panel.

In addition, it is preferable to mix a filler with a high refractive index or light-scattering member into the resin, in which case light extraction efficiency can be enhanced. For example, titanium oxide, barium oxide, zeolite, zirconium, or the like can be used.

### [Connection Layer]

As the connection layer, an anisotropic conductive film (ACF), an anisotropic conductive paste (ACP), or the like can be used.

The above is the description of each of the components.

At least part of this embodiment can be implemented in combination with any of the other embodiments described in this specification as appropriate.

### Embodiment 6

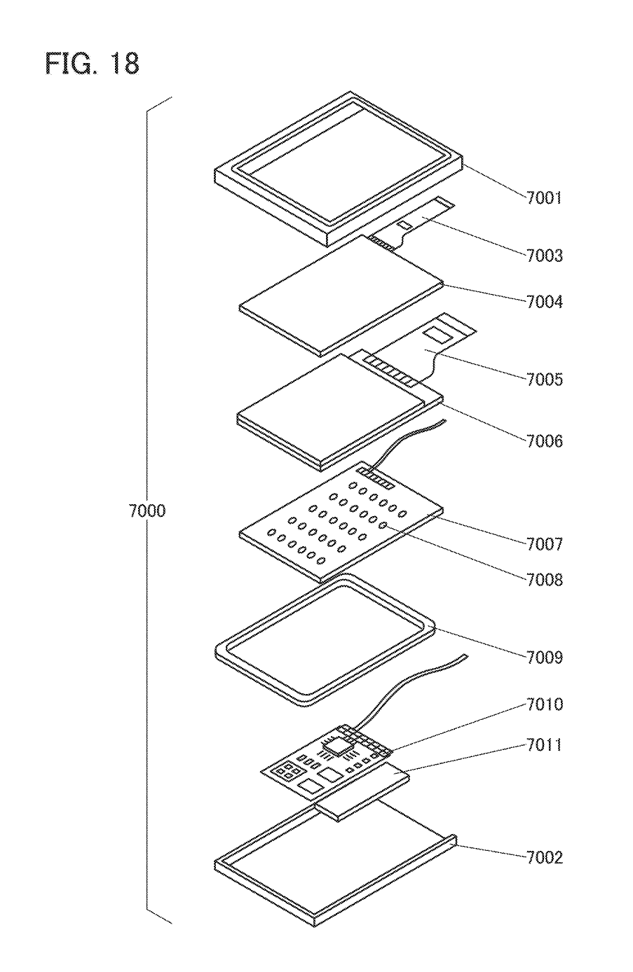

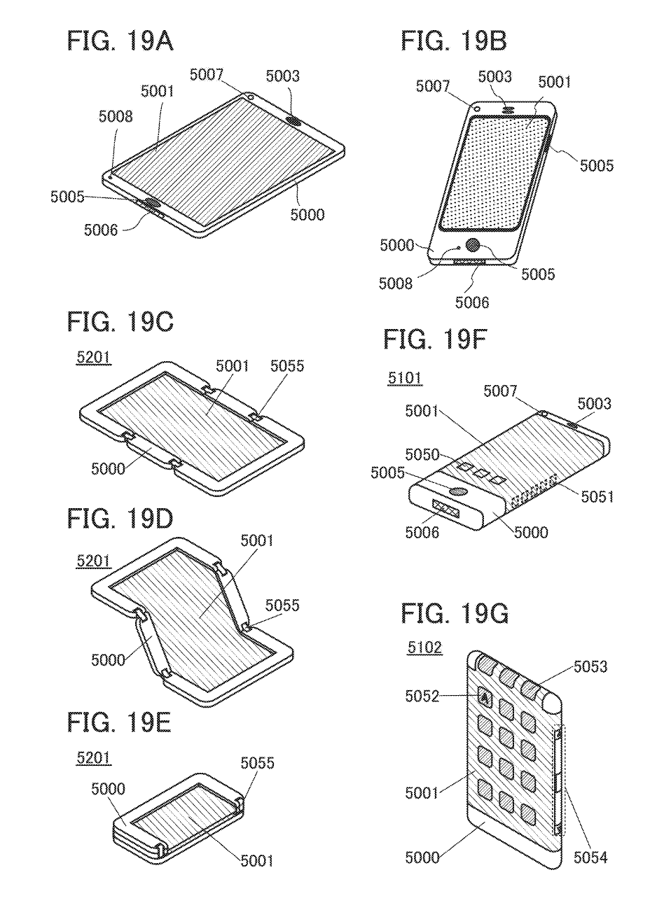

In this embodiment, a display module and electronic devices, to which input is provided with use of the touch pen of one embodiment of the present invention, will be described with reference to FIG. 18, FIGS. 19A to 19G, FIGS. 20A to 20F, and FIGS. 21A to 21F.

### <6-1. Display Module>

In a display module 7000 illustrated in FIG. 18, a touch panel 7004 connected to an FPC 7003, a display panel 7006 connected to an FPC 7005, a backlight 7007, a frame 7009, a printed-circuit board 7010, and a battery 7011 are provided between an upper cover 7001 and a lower cover 7002.

The shapes and sizes of the upper cover 7001 and the lower cover 7002 can be changed as appropriate in accordance with the sizes of the touch panel 7004 and the display panel 7006.

The touch panel 7004 can be the touch panel described in the above embodiment and overlap with the display panel 7006. Alternatively, a counter substrate (sealing substrate) of the display panel 7006 can have a touch panel function. Alternatively, a photosensor may be provided in each pixel of the display panel 7006 to form an optical touch panel.

The backlight 7007 includes a light source 7008. One embodiment of the present invention is not limited to the structure in FIG. 18, in which the light source 7008 is provided over the backlight 7007. For example, a structure in which the light source 7008 is provided at an end portion of the backlight 7007 and a light diffusion plate is further provided may be employed. Note that the backlight 7007 need not be provided in the case where a self-luminous light-emitting element such as an organic EL element is used or in the case where a reflective panel or the like is employed.

The frame 7009 protects the display panel 7006 and functions as an electromagnetic shield for blocking electromagnetic waves generated by the operation of the printed-circuit board 7010. The frame 7009 may also function as a radiator plate.

The printed-circuit board 7010 includes a power supply circuit and a signal processing circuit for outputting a video signal and a clock signal. As a power source for supplying power to the power supply circuit, an external commercial power source or the separately provided battery 7011 may be used. The battery 7011 can be omitted in the case where a commercial power source is used.

The display module 7000 may be additionally provided with a member such as a polarizing plate, a retardation plate, or a prism sheet.

### <6-2. Electronic Devices>

Next, FIGS. 19A to 21F illustrate examples of electronic devices. These electronic devices can each include a housing 5000, a display portion 5001, a speaker 5003, an LED lamp 5004, an operation key 5005 (including a power switch or an operation switch), a connection terminal 5006, a sensor 5007 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared ray), a microphone 5008, and the like. Note that a touch panel is provided in the display portion 5001.

For input to the touch panel provided in the display portion, the touch pen of one embodiment of the present invention can be used as an input means other than a finger. Using the touch pen of one embodiment of the present invention, a user can provide input to the touch panel, feeling as if he/she is drawing with a writing instrument on a piece of paper. Input with the pen tip, which is thinner than a finger, can prevent incorrect input.

FIG. 19A illustrates an example of a tablet information terminal, which is an example of an information terminal. FIG. 19B illustrates an example of a smartphone or mobile phone, which is another example of an information terminal.

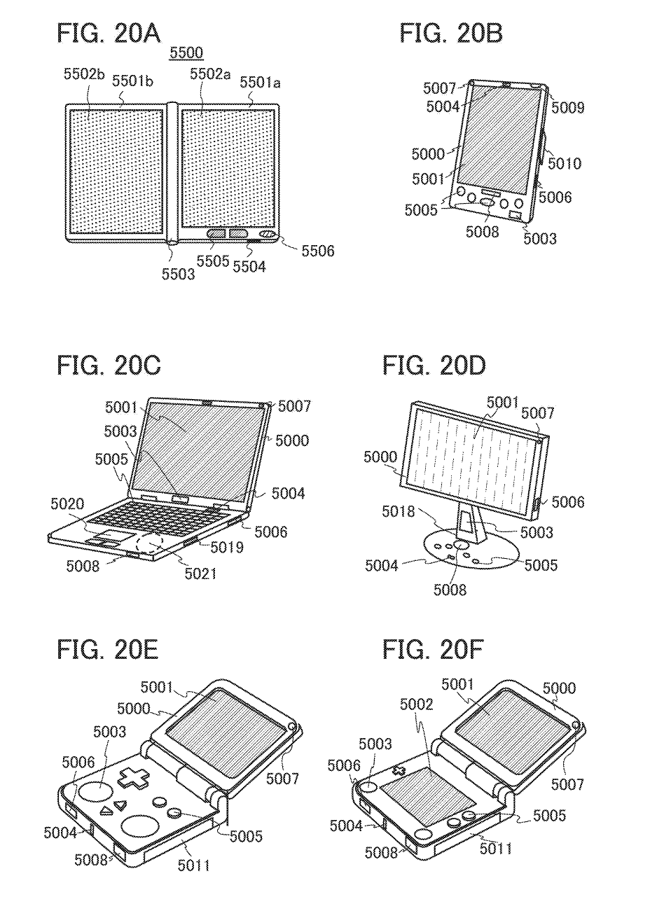

FIGS. 19C, 19D, 19E, 19F, 19G, and 20A illustrate other examples of an information terminal than those illustrated in FIGS. 19A and 19B.

FIGS. 19C, 19D, and 19E are perspective views of a foldable information terminal 5201. FIG. 19C is a perspective view of the information terminal 5201 that is opened. FIG. 19D is a perspective view of the information terminal 5201 that is being opened or being folded. FIG. 19E is a perspective view of the information terminal 5201 that is folded. The information terminal 5201 is highly portable when folded. When the information terminal 5201 is opened, the seamless large display region is highly browsable. The display portion 5001 of the information terminal 5201 is supported by three housings 5000 joined together by hinges 5055. By folding the information terminal 5201 at a connection portion between two housings 5000 with the hinges 5055, the information terminal 5201 can be reversibly changed in shape from an opened state to a folded state. The information terminal 5201 can be bent with a radius of curvature of 1 mm to 150 mm inclusive, for example.

FIG. 19F is a perspective view of an information terminal 5101. The information terminal 5101 has one or more functions selected from a telephone set, a notebook, an information browsing system, and the like, for example. Specifically, the information terminal 5101 can be used as a smartphone. The information terminal 5101 includes a display portion 5001 that is partly curved. The display portion 5001 is provided not only on the front but also on the side of a housing 5000 to display images. The display portion 5001 may also be provided on the other side of the housing 5000. The display portion 5001 can display character or image data on the multiple surfaces. For example, three operation buttons 5050 (also referred to as operation icons or simply as icons) can be displayed on one surface of the display portion 5001. Furthermore, information 5051 indicated by dashed rectangles can be displayed on another surface of the display portion 5001. Examples of the information 5051 include display indicating reception of an incoming email, social networking service (SNS) message, call, and the like; the title and sender of an email or an SNS message; the date; the time; remaining battery; and the reception strength of an antenna. Alternatively, the operation buttons 5050 or the like may be displayed on where the information 5051 is displayed, and may replace the information 5051.

FIG. 19G is a perspective view of an information terminal 5102. The information terminal 5102 includes a display portion 5001 that is partly curved, and is capable of displaying information on three or more surfaces of a housing 5000. Specifically, information can be displayed on the front surface, the top surface, and the side surface that is in contact with the front and top surfaces. Furthermore, the display portion 5001 may be provided on the front surface and the top and two side surfaces that are in contact with the front surface, in which case information can be displayed on the four surfaces in total. Here, an example in which information 5052, information 5053, and information 5054 are displayed on different surfaces is shown. A user of the information terminal 5102 can see the display (here, the information 5053) with the information terminal 5102 put in the breast pocket of his/her clothes, for example. Specifically, the caller's phone number, name, or the like of an incoming call is displayed in the position that can be seen from above the information terminal 5102. Thus, the user can see the display without taking out the information terminal 5102 from the pocket and decide whether to answer the call.

FIG. 20A illustrates an example of a foldable tablet terminal (in an open state). A tablet terminal 5500 includes a housing 5501a, a housing 5501b, a display portion 5502a, and a display portion 5502b. The housings 5501a and 5501b are connected by a hinge 5503 and can be opened or closed with the hinge 5503 as an axis. Thus, the tablet terminal 5500 is highly portable when folded, and has high browsability in display when opened. The housing 5501a includes a power switch 5504, operation keys 5505, a speaker 5506, and the like.

At least part of the display portion 5502a or the display portion 5502b can be used as a touch panel region where data can be input by touching displayed operation keys. For example, a keyboard can be displayed on the entire display portion 5502a to be used as a touch panel, and the display portion 5502b can be used as a display screen. For input to the touch panel provided in the display portion, the touch pen of one embodiment of the present invention can be used as an input means other than a finger. Using the touch pen of one embodiment of the present invention, a user can provide input to the touch panel, feeling as if he/she is drawing with a writing instrument on a piece of paper. Furthermore, input with the pen tip, which is thinner than a finger, can prevent incorrect input.

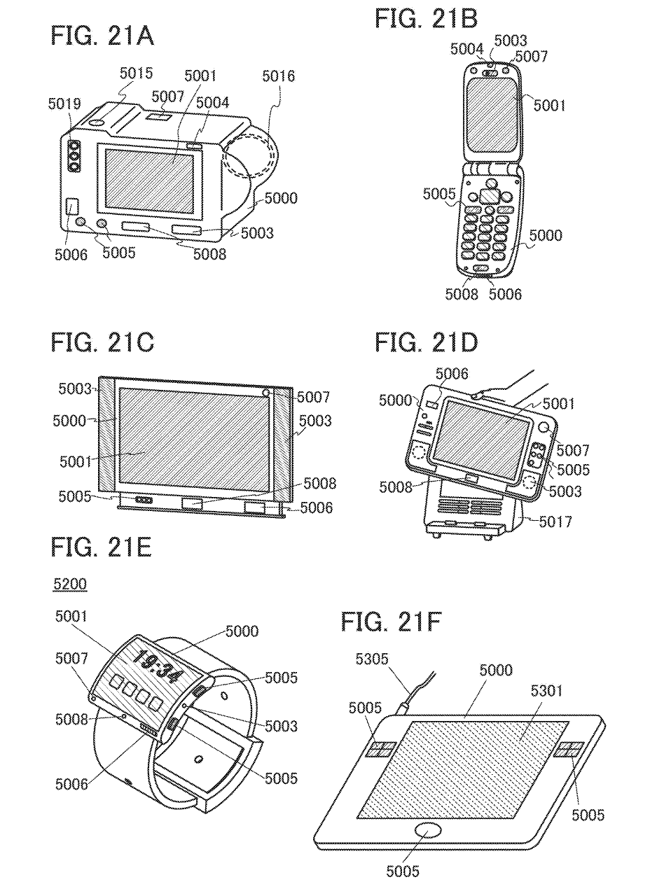

FIG. 20B illustrates a mobile computer, which can include a switch 5009, an infrared port 5010, and the like in addition to the above components. FIG. 20C illustrates a computer, which can include a pointing device 5020, the external connecting port 5019, a reader/writer 5021, and the like in addition to the above components. FIG. 20D illustrates a display, which can include a support base 5018 and the like in addition to the above components. FIG. 20E illustrates a portable game console, which can include a recording medium reading portion 5011 and the like in addition to the above components. FIG. 20F illustrates a portable game console, which can include a second display portion 5002, a recording medium reading portion 5011, and the like in addition to the above components. FIG. 21A illustrates a camera, which can include an external connection port 5019, a shutter button 5015, an image reception portion 5016, and the like in addition to the above components. FIG. 21B illustrates a mobile phone, which can include a transmitter, a receiver, a tuner of one-segment partial reception service for mobile phones and mobile terminals, and the like in addition to the above components. FIG. 21C illustrates a television set, which can include a tuner, an image processing portion, and the like in addition to the above components. FIG. 21D illustrates a portable television receiver, which can include a charger 5017 capable of transmitting and receiving signals and the like in addition to the above components.

FIG. 21E is a perspective view of a wrist-watch-type information terminal 5200. A user can wear the information terminal 5200 on the wrist, so that the information terminal 5200 can be used as a portable information terminal that is easily carried around. The information terminal 5200 is capable of executing a variety of applications such as mobile phone calls, e-mailing, viewing and editing texts, music reproduction, Internet communication, and computer games. The display surface of the display portion 5001 is curved, and images can be displayed on the curved display surface. The information terminal 5200 can employ near field communication conformable to a communication standard. In that case, for example, mutual communication between the information terminal 5200 and a headset capable of wireless communication can be performed, and thus hands-free calling is possible. The information terminal 5200 includes a connection terminal 5006, and data can be directly transmitted to and received from another information terminal via a connector. Charging through the connection terminal 5006 is also possible. Note that the charging operation may be performed by wireless power feeding without using the connection terminal 5006.

FIG. 21F is a perspective view of a graphics tablet, which is an example of an electronic device without a display portion. A housing 5000 is provided with an input portion 5301 having a touch panel, operation keys 5005 (including a power switch or an operation switch), and an output cable 5305. Data input from the input portion 5301 or the operation keys 5005 are conveyed through the output cable 5305 and input to an electronic device such as a computer. Alternatively, the graphics tablet may be incorporated in an electronic device such as a computer, and may be used as the pointing device 5020 of the computer in FIG. 20C. In the case where the graphics tablet has a wireless communication function, the output cable 5305 need not necessarily be provided.

Most of the electronic devices described in this embodiment each include the display portion for displaying some sort of data. However, the electronic devices to which input is provided using the touch pen of one embodiment of the invention may be an electronic device without a display portion.

At least part of this embodiment can be implemented in combination with any of the other embodiments described in this specification as appropriate.

Note that in this specification and the like, part of a diagram or a text described in one embodiment can be taken out to constitute one embodiment of the invention. Thus, in the case where a diagram or a text related to a certain part is described, a content taken out from the diagram or the text of the certain part is also disclosed as one embodiment of the invention and can constitute one embodiment of the invention. Accordingly, for example, part of a diagram or a text including one or more of active elements (e.g., transistors and diodes), wirings, passive elements (e.g., capacitors and resistors), conductive layers, insulating layers, semiconductor layers, organic materials, inorganic materials, components, devices, operating methods, manufacturing methods, and the like can be taken out to constitute one embodiment of the invention. For example, from a circuit diagram in which N circuit elements (e.g., transistors or capacitors; N is an integer) are provided, it is possible to take out M circuit elements (e.g., transistors or capacitors; M is an integer, where M<N) to constitute one embodiment of the invention. For another example, from a cross-sectional view in which N layers (N is an integer) are provided, it is possible to take out M layers (M is an integer, where M<N) to constitute one embodiment of the invention. For another example, from a flow chart in which N elements (N is an integer) are provided, it is possible to take out M elements (M is an integer, where M<N) to constitute one embodiment of the invention.

Note that, in the case where at least one specific example is described in a diagram or a text described in one embodiment in this specification and the like, it will be readily appreciated by those skilled in the art that a broader concept of the specific example can be derived. Thus, in the case where at least one specific example is described in the diagram or the text described in one embodiment, a broader concept of the specific example is disclosed as one embodiment of the invention and can constitute one embodiment of the invention.

Note that in this specification and the like, a content described in at least a diagram (which may be part of the diagram) is disclosed as one embodiment of the invention, and can constitute one embodiment of the invention. Thus, when a certain content is described in a diagram, the content is disclosed as one embodiment of the invention even when the content is not described with a text, and can constitute one embodiment of the invention. In a similar manner, part of a diagram, which is taken out from the diagram, is disclosed as one embodiment of the invention, and can constitute one embodiment of the invention.

This application is based on Japanese Patent Application Serial No. 2016-159930 filed with Japan Patent Office on Aug. 17, 2016, the entire contents of which are hereby incorporated by reference.

What is claimed is:

1. A touch pen comprising:
a first housing;
a second housing at an end portion of the first housing; and
a first ball,
wherein at least a portion of the first ball is inside the second housing, and
wherein the first ball includes an elastic material.

2. The touch pen according to claim 1, wherein the first ball includes a plurality of protrusions and depressions.

3. The touch pen according to claim 1, wherein an inner surface of the second housing includes a plurality of protrusions and depressions.

4. The touch pen according to claim 1, wherein the Young's modulus of the elastic material in the first ball is higher than or equal to 28 MPa and lower than or equal to 107 MPa.

5. The touch pen according to claim 1, wherein the first ball comprises rubber.

6. The touch pen according to claim 1, wherein the first ball comprises plastic.

7. The touch pen according to claim 1,
wherein the first ball includes a central portion comprising a first material and a peripheral portion comprising a second material, and
wherein the Young's modulus of the first material is different from the Young's modulus of the second material.

8. The touch pen according to claim 1, further comprising a second ball,
wherein the second ball is inside the second housing, and
wherein the second ball touches the first ball and the second housing.

9. The touch pen according to claim 1, wherein the first ball is configured to rotate in the second housing and move on a touch panel of an electronic device such that an input is provided to the touch panel.

10. The touch pen according to claim 9, wherein the coefficient of kinetic friction between the touch pen and the touch panel is greater than or equal to 0.4 and less than or equal to 0.6.

11. A touch pen comprising:
a first housing;
a second housing;
a spring between the first housing and the second housing; and
a first ball,
wherein the second housing is movable with respect to the first housing, and
wherein at least a portion of the first ball is inside the second housing.

12. The touch pen according to claim 11, wherein the first ball includes a plurality of protrusions and depressions.

13. The touch pen according to claim 11, wherein an inner surface of the second housing includes a plurality of protrusions and depressions.

14. The touch pen according to claim 11, wherein the first ball comprises rubber.

15. The touch pen according to claim 11, wherein the first ball comprises plastic.

16. The touch pen according to claim 11,
wherein the first ball includes a central portion comprising a first material and a peripheral portion comprising a second material, and
wherein the Young's modulus of the first material is different from the Young's modulus of the second material.

17. The touch pen according to claim 11, further comprising a second ball,
wherein the second ball is inside the second housing, and
wherein the second ball touches the first ball and the second housing.

18. The touch pen according to claim 11, wherein the first ball is configured to rotate in the second housing and move on a touch panel of an electronic device such that an input is provided to the touch panel.

19. The touch pen according to claim 18, wherein the coefficient of kinetic friction between the touch pen and the touch panel is greater than or equal to 0.4 and less than or equal to 0.6.
